(19) United States
(12) Patent Application Publication
(10) Pub. No.: US 2026/0302584 A1
(43) Pub. Date: Oct. 1, 2026

(54) ANTENNA DEVICE COMPRISING A WAVEGUIDE

(71) Applicant: QUALCOMM Incorporated, San Diego, CA (US)

(72) Inventors: Jeahyeong HAN, San Diego, CA (US); Jaehyun YEON, San Diego, CA (US); Jeongil Jay KIM, San Diego, CA (US); Dong Gun KAM, San Diego, CA (US); Rajneesh KUMAR, San Diego, CA (US)

(21) Appl. No.: 19/090,144

(22) Filed: Mar. 25, 2025

(51) Int. Cl. H01P 3/16; H01Q 13/28

(52) U.S. Cl. CPC H01P 3/16; H01Q 13/28

(57) ABSTRACT

An antenna device comprising an antenna device dielectric layer; at least one antenna located in the antenna device dielectric layer; at least one waveguide metal layer; and at least one opening on a first surface of the antenna device. The at least one waveguide metal layer is configured as a waveguide for the antenna device.

### FIELD

Various features relate to packages, substrates and antennas.

### BACKGROUND

Packages can include a substrate, an integrated device and an antenna. Antennas help provide wireless connectively to/from devices. However, as devices get smaller and smaller, the components in these devices also need to get smaller in order to fit in these smaller devices. There is an ongoing need to provide antennas with improved form factors and improved directional control, while also maintaining and/or improving the performances of the antennas, which can lead to improved performances for the devices and/or the packages.

### SUMMARY

Various features relate to packages, substrates and antennas.

One example provides an antenna device comprising an antenna device dielectric layer; at least one antenna located in the antenna device dielectric layer; at least one waveguide metal layer; and at least one opening on a first surface of the antenna device.

Another example provides an antenna device comprising an antenna device dielectric layer; at least one antenna feed located in the antenna device dielectric layer; a waveguide antenna; and at least one opening on a first surface of the antenna device.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 illustrates an exemplary profile view of an antenna package that includes an antenna device comprising a waveguide.

FIG. 2 illustrates an exemplary cross sectional profile view of an antenna device comprising a waveguide.

FIG. 3 illustrates an exemplary cross sectional profile view of an antenna device comprising a waveguide.

FIG. 4 illustrates an exemplary cross sectional profile view of an antenna device comprising a waveguide.

FIG. 5 illustrates an exemplary cross sectional profile view of an antenna device comprising a waveguide.

FIG. 6 illustrates an exemplary view of an antenna device comprising a waveguide.

FIG. 7 illustrates an exemplary view of an antenna device comprising a waveguide.

FIG. 8 illustrates an exemplary view of an antenna device comprising a waveguide.

FIG. 9 illustrates an exemplary view of an antenna device comprising a waveguide.

FIG. 10 illustrates an exemplary view of an antenna device comprising a waveguide.

FIG. 11 illustrates an exemplary cross sectional profile view of a package comprising antenna devices comprising a waveguide.

FIG. 12 illustrates an exemplary cross sectional plan view of a package comprising antenna devices comprising a waveguide.

FIG. 13 illustrates an exemplary profile view of another antenna package that includes an antenna device comprising a waveguide.

FIG. 14 illustrates an exemplary profile view of another antenna package that includes an antenna device comprising a waveguide.

FIG. 15 illustrates an exemplary profile view of an antenna package that includes an antenna device comprising a waveguide.

FIG. 16 illustrates an exemplary profile view of another antenna package that includes an antenna device comprising a waveguide.

FIGS. 17A-17E illustrate an exemplary sequence for fabricating an antenna device.

FIG. 18 illustrates an exemplary sequence for fabricating an antenna device.

FIGS. 19A-19E illustrate an exemplary sequence for fabricating an antenna device.

FIG. 20 illustrates an exemplary sequence for fabricating an antenna device.

FIG. 21 illustrates various electronic devices that may integrate a die, an electronic circuit, an integrated device, an integrated passive device (IPD), a passive component, a package, and/or a device package described herein.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The present disclosure describes a package that includes an antenna device comprising an antenna device dielectric layer; at least one antenna located in the antenna device dielectric layer; at least one waveguide metal layer; and at least one opening on a first surface of the antenna device. The antenna device may further comprise a solder resist layer coupled to a surface of the antenna device dielectric layer. The at least one waveguide metal layer may be coupled to the solder resist layer. The solder resist layer may be located between the at least one waveguide metal layer and the antenna device dielectric layer. The at least one antenna may be configured as at least one antenna feed for the antenna device. The at least one waveguide metal layer may be configured as a waveguide antenna for the antenna device. The at least one waveguide metal layer may help provide improved directional transmission and/or reception of signals from and/or to the antenna device.

### Exemplary Package With an Antenna Device Comprising a Waveguide

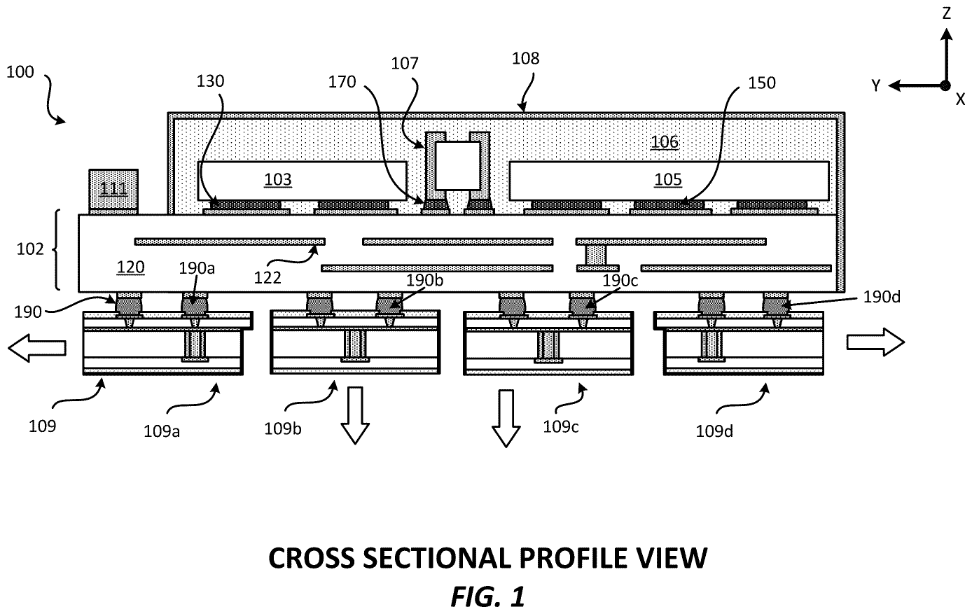

FIG. 1 illustrates an exemplary cross sectional profile view of a package 100 that includes an antenna device with a wave guide. The package 100 may be an antenna package. The package 100 includes a substrate 102, an integrated device 103, an integrated device 105, a passive device 107, an encapsulation layer 106, a shield 108, a plurality of antenna devices 109 and a connector 111. One or more antenna devices from the plurality of antenna devices 109, may include a waveguide. In some implementations, the waveguide may be a waveguide antenna.

The substrate 102 includes at least one dielectric layer 120 (e.g., substrate dielectric layer) and a plurality of interconnects 122 (e.g., substrate interconnects). The integrated device 103 is coupled to a first surface of the substrate 102 through at least a plurality of solder interconnects 130. The plurality of solder interconnects 130 may be coupled to the integrated device 103 and interconnects from the plurality of interconnects 122. The integrated device 105 is coupled to the first surface of the substrate 102 through at least a plurality of solder interconnects 150. The plurality of solder interconnects 150 may be coupled to the integrated device 105 and interconnects from the plurality of interconnects 122. The passive device 107 is coupled to the first surface of the substrate 102 through at least a plurality of solder interconnects 170. The plurality of solder interconnects 170 may be coupled to the passive device 107 and interconnects from the plurality of interconnects 122. The encapsulation layer 106 is coupled to the first surface of the substrate 102. The encapsulation layer 106 may encapsulate the integrated device 103, the integrated device 105, the passive device 107, the plurality of solder interconnects 130, the plurality of solder interconnects 150 and/or the plurality of solder interconnects 170. The encapsulation layer 106 may include a mold, a resin, an epoxy and/or a filler. The shield 108 may be coupled to an outer surface of the encapsulation layer 106. The shield 108 may also be coupled to a side portion and/or side wall of the substrate 102. The shield 108 may be configured as an electromagnetic interference (EMI) shield for the integrated device 103 and/or the integrated device 105. The shield 108 may include one or more metal layers that are coupled to and touching a surface of the encapsulation layer 106. The one or more metal layers of the shield 108, may also be coupled to and touching a side surface of the substrate 102. The one or more metal layers of the shield 108 may be touching the at least one dielectric layer 120 of the substrate 102.

The connector 111 is coupled to the first surface of the substrate 102. Part of the connector 111 may be embedded in the substrate 102. The connector 111 may be configured to provide electrical paths for millimeter wave signals. The connector 111 may include interconnects configured as coaxial interconnects. The connector 111 may include a plurality of pins (not shown). The plurality of pins may be configured to provide electrical paths for power, ground and signals (e.g., millimeter wave signals). The connector 111 may be configured to be electrically coupled to the integrated device 103, the integrated device 105 and/or the plurality of antenna devices 109, through the substrate 102. A cable (not shown) may be coupled to the connector 111. The cable (not show) may be configured to be coupled to a board (e.g., printed circuit board).

The plurality of antenna devices 109 include an antenna device 109a, an antenna device 109b, an antenna device 109c and an antenna device 109d. The plurality of antenna devices 109 may be coupled to a second surface of the substrate 102 through a plurality of solder interconnects 190. The plurality of solder interconnects 190 include a plurality of solder interconnects 190a, a plurality of solder interconnects 190b, a plurality of solder interconnects 190c and a plurality of solder interconnects 190d.

The antenna device 109a is coupled to a second surface of the substrate 102 through the plurality of solder interconnects 190a. The plurality of solder interconnects 190a is coupled to the antenna device 109a and interconnects from the plurality of interconnects 122 of the substrate 102. The antenna device 109b is coupled to a second surface of the substrate 102 through the plurality of solder interconnects 190b. The plurality of solder interconnects 190b is coupled to the antenna device 109b and interconnects from the plurality of interconnects 122 of the substrate 102. The antenna device 109c is coupled to a second surface of the substrate 102 through the plurality of solder interconnects 190c. The plurality of solder interconnects 190c is coupled to the antenna device 109c and interconnects from the plurality of interconnects 122 of the substrate 102. The antenna device 109d is coupled to a second surface of the substrate 102 through the plurality of solder interconnects 190d. The plurality of solder interconnects 190d is coupled to the antenna device 109d and interconnects from the plurality of interconnects 122 of the substrate 102.

As will be further described below, one of more antenna devices from the plurality of antenna devices 109 may include a waveguide. The waveguide helps provide directional capabilities for an antenna device. For example, the waveguide of an antenna device may be configured so that the antenna device transmits and/or receives signals in one or more specific directions. Different implementations may have different waveguides that are configured differently. As shown in FIG. 1, the antenna device 109a includes a waveguide that is configured to transmit and/or receive signals in a first Y direction (e.g., first horizontal direction). The antenna device 109d includes a waveguide that is configured to transmit and/or receive signals in a second Y direction (e.g., second horizontal direction), where the second Y direction is opposite to the first Y direction. The antenna device 109b includes a waveguide that is configured to transmit and/or receive signals in a first Z direction. The antenna device 109c includes a waveguide that is configured to transmit and/or receive signals in a first Z direction (e.g., first vertical direction). In some implementations, the waveguide may be considered as the antenna (e.g., waveguide antenna) for the antenna device. In some implementations, the waveguide may be considered as the radiating element of the antenna device.

As will be further described below, each antenna device (e.g., 109a, 109b, 109c, 109d) may be configured to transmit and/or receive signals at different frequencies and/or different ranges of frequencies. In some implementations, each antenna device may include several antennas that are each configured to transmit and/or receive signals at different frequencies and/or different ranges of frequencies.

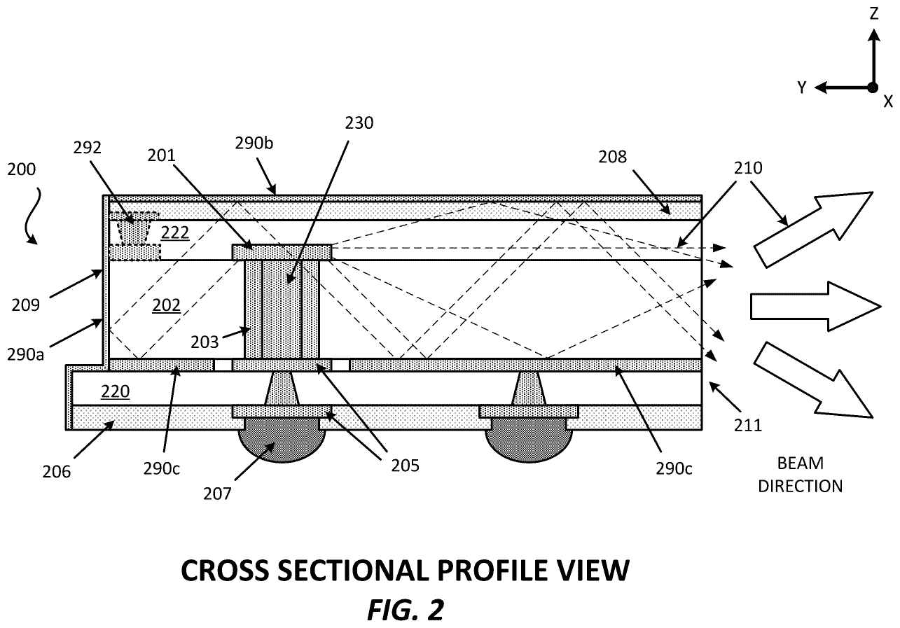

FIG. 2 illustrates an exemplary cross sectional profile view of an antenna device 200. The antenna device 200 may represent any of the antenna devices from the disclosure, such as for example, the antenna device 109a. The antenna device 200 includes an antenna 201, a core layer 202, a dielectric layer 220, a dielectric layer 222, a via interconnect 203, a plurality of interconnects 205, a solder resist layer 206, a solder resist layer 208 and a waveguide 209. The antenna device 200 may also include a plurality of solder interconnects 207.

The antenna 201 is located within the antenna device 200. The antenna 201 is coupled to at least one via interconnect 203. The at least one via interconnect 203 is located in the core layer 202. The at least one via interconnect 203 may include an inner via interconnect 230. The core layer 202 may be include a dielectric. The dielectric layer 222 is coupled to a first surface of the core layer 202. The dielectric layer 222 is coupled to a second surface of the core layer 202. The at least one via interconnect 203 is coupled to the plurality of interconnects 205. The plurality of interconnects 205 are coupled to the plurality of solder interconnects 207. The solder resist layer 206 may be coupled to the dielectric layer 220. The solder resist layer 208 may be coupled to the dielectric layer 222. In some implementations, instead of the inner via interconnect 230, a dielectric layer and/or a filler may be used. In such instances, the via interconnect 203 may laterally surround the dielectric layer and/or the filler that occupies the space and region shown as the inner via interconnect 230. The dielectric layer and/or the filler may be similar or the same as the dielectric layer 220 and/or the dielectric layer 222. In some implementations, the antenna 201 may be considered as an antenna feed for the antenna device. In some implementations, the antenna 201, the via interconnect 203 and/or the plurality of interconnects 205 may be considered as an antenna feed for the antenna device. The waveguide 209 may at least partially surround the antenna 201.

The waveguide 209 may include a metal layer 290a, a metal layer 290b and a metal layer 290c. The metal layer 290a, the metal layer 290b and/or the metal layer 290c may be waveguide metal layers. The metal layer 290a, the metal layer 290b and/or the metal layer 290c may be reflective metal layers (e.g., signal reflective metal layers). The metal layer 290a is coupled to and touch the metal layer 290b and the metal layer 290c. The metal layer 290a may be coupled to a first side surface of the antenna device 200. The metal layer 290a may be coupled to a side surface of the core layer 202, a side surface of the dielectric layer 222, a side surface of the dielectric layer 220, a side surface of the solder resist layer 206 and/or a side surface of the solder resist layer 208. The metal layer 290b may be coupled to a first horizontal surface of the antenna device 200. For example, the metal layer 290b may be coupled to a top horizontal surface of the antenna device 200. The metal layer 290b may be coupled to the solder resist layer 208. The metal layer 290c may be coupled to the core layer 202. The metal layer 290c may be located between the core layer 202 and the dielectric layer 220. The metal layer 290c may touch the core layer 202 and the dielectric layer 220. The metal layer 290c may be located between the core layer 202 and the solder resist layer 206. The waveguide 209 may include other metal layers (not shown) that are formed on other side surfaces of the antenna device 200, in a similar manner as described for the metal layer 290a. For example, the waveguide 209 may include another waveguide metal layer that is coupled to a second side surface of the antenna device 200, and yet another waveguide metal layer that is coupled to a third side surface of the antenna device 200. In some implementations, the metal layer 290a, the metal layer 290b, the metal layer 290c and/or other waveguide metal layers may be configured to be electrically coupled to ground. In some implementations, a plurality of interconnects 292 may be coupled to the metal layer 290a and the metal layer 290b.

The metal layer 290a, the metal layer 290b, the metal layer 290c and/or other waveguide metal layers as described in the disclosure, may be configured to operate as a reflective metal layer that reflects signals 210 (e.g., beams) inside the antenna device 200, such that the signals 210 transmit and/or exit through a side portion 211 (e.g., side opening) of the antenna device 200. Thus, the metal layer 290a, the metal layer 290b, the metal layer 290c and/or other waveguide metal layers reflect, guide and/or direct the signals to emit and/or transmit in a particular direction and/or in a general particular direction. Similarly, the metal layer 290a, the metal layer 290b, the metal layer 290c and/or other waveguide metal layers may guide and/or reflect signals that enter through the side portion 211 towards the antenna 201 of the antenna device 200. It is noted that the paths of the signals are exemplary. Different signals may reflect and/or travel inside the antenna device 200 differently.

The waveguide 209 may form a partial enclosure that partially encloses and/or surrounds the antenna 201. The waveguide 209 is configured so that more signals are transmitted towards one or more particular directions, while stopping, reducing and/or minimizing signals that are transmitted in one or more other different directions. This can lead to improved performance, since the antenna device may be located directly adjacent to a device and/or component that will block or absorb signals. Thus, by directing the signals in a different direction and/or away from the directly adjacent device and/or component, more of the signals will be able to travel to a device that can receive and process of the signals. By focusing the signals in certain directions, the signals will be inherently more powerful in a certain direction. Different implementations may have an antenna device with a waveguide and/or a waveguide antenna with different configurations. Some of the signal directions, may include signal directions that are opposite to each other, and/or signal directions that are orthogonal to each other.

In some implementations, the waveguide 209 may be considered as the antenna (e.g., waveguide antenna) for the antenna device 200. In such instances, the antenna 201 and/or the via interconnect 203 may be considered as the antenna feed for the antenna device 200. For example, in transmission mode of the antenna device 200, signals (e.g., radio frequency (RF) signals, transmitting RF signals) may travel through the plurality of interconnects 205, the via interconnect 203 and the antenna 201, and is transmitted and/or feed to the waveguide 209, which radiates the signals outside of the antenna device 200. In some implementations, signals may radiate from the via interconnect 203 and/or the antenna 201 to outside of the antenna device 200 without first bouncing off of the waveguide 209. In some implementations, in reception mode and/or receiving mode, signals (e.g., RF signals, receiving RF signals) from outside of the antenna device 200 may be captured by the waveguide 209 and emitted and/or reflected towards the antenna 201 and/or the via interconnect 203, where the signals may then travel through the plurality of interconnects 205 and the plurality of solder interconnects 207. In some implementations, the antenna 201 and/or the via interconnect 203 may receive a signals that have not bounced off the waveguide 209.

Thus, as described above, in some implementations, the waveguide 209 may be considered as an antenna for the antenna device 200, and the antenna 201 may be considered as an antenna feed for the antenna device 200. In some implementations, the antenna 201, the via interconnect 203 and/or the plurality of interconnects 205 may be considered as an antenna feed for the antenna device 200. In some implementations, (i) the combination of the antenna 201 and the waveguide 209 may be considered as an antenna for the antenna device 200, and (ii) the via interconnect 203 and/or the plurality of interconnects 205 may be considered as the antenna feed for the antenna device 200. As mentioned above, the waveguide 209 may form a partial enclosure with a side portion 211, where signals may enter and/or exit the enclosure through the side portion 211. The side portion 211 may be an opening in the enclosure of the waveguide 209. An opening of the antenna device may be a region and/or a surface of the antenna device 200 that is not covered with the waveguide 209. The waveguide 209 may partially surround the antenna 201. In some implementations, the waveguide antenna of the antenna device may partially surround the antenna feed of the antenna device.

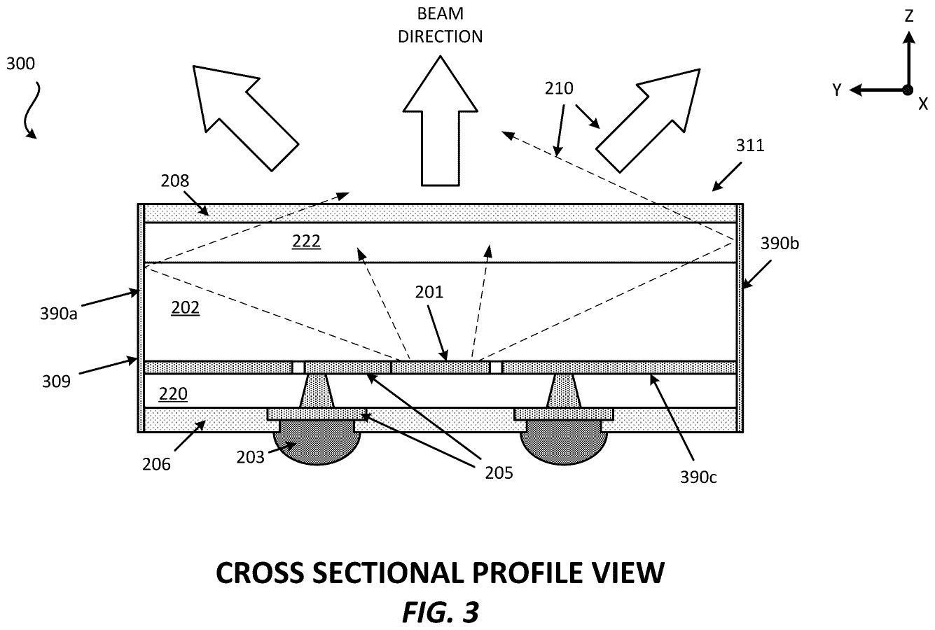

FIG. 3 illustrates an exemplary cross sectional profile view of an antenna device 300. The antenna device 300 may represent any of the antenna devices from the disclosure, such as for example, the antenna device 109a. The antenna device 300 includes an antenna 201, a core layer 202, a dielectric layer 220, a dielectric layer 222, a plurality of interconnects 205, a solder resist layer 206, a solder resist layer 208 and a waveguide 309. The antenna device 200 may also include a plurality of solder interconnects 207.

The antenna 201 is located within the antenna device 300. The antenna 201 is coupled to plurality of interconnects 205. The core layer 202 may be include a dielectric. The dielectric layer 222 is coupled to a first surface of the core layer 202. The dielectric layer 222 is coupled to a second surface of the core layer 202. The plurality of interconnects 205 are coupled to the plurality of solder interconnects 207. The solder resist layer 206 may be coupled to the dielectric layer 220. The solder resist layer 208 may be coupled to the dielectric layer 222.

The waveguide 309 may form a partial enclosure that partially encloses and/or surrounds the antenna 201. In some implementations, the antenna 201 may be planar and/or co-planar to a surface of the waveguide 309. The waveguide 309 may include a metal layer 390a, a metal layer 390b and a metal layer 390c. The metal layer 390a, the metal layer 390b and/or the metal layer 390c may be waveguide metal layers. The metal layer 390a, the metal layer 390b and/or the metal layer 390c may be reflective metal layers (e.g., signal reflective metal layers). The metal layer 390b is coupled to the metal layer 390a and the metal layer 390c. The metal layer 390a may be coupled to a first side surface of the antenna device 300. The metal layer 390a may be coupled to a side surface of the core layer 202, a side surface of the dielectric layer 222, a side surface of the dielectric layer 220, a side surface of the solder resist layer 206 and/or a side surface of the solder resist layer 208. The metal layer 390b may be coupled to a second side surface of the antenna device 300. The metal layer 390b may be coupled to a side surface of the core layer 202, a side surface of the dielectric layer 222, a side surface of the dielectric layer 220, a side surface of the solder resist layer 206 and/or a side surface of the solder resist layer 208.

The metal layer 390c may be planar and/or co-planar to the antenna 201. The metal layer 390c may be located between the core layer 202 and the dielectric layer 220. The metal layer 390c may touch the core layer 202 and the dielectric layer 220. The metal layer 390c may be located between the core layer 202 and the solder resist layer 206. The waveguide 309 may include other metal layers (not shown) that are formed on other side surfaces of the antenna device 300, in a similar manner as described for the metal layer 390a. For example, the waveguide 309 may include another waveguide metal layer that is coupled to a third side surface of the antenna device 300, and yet another waveguide metal layer that is coupled to a fourth side surface of the antenna device 300. In some implementations, the metal layer 390a, the metal layer 390b, the metal layer 390c and/or other waveguide metal layers may be configured to be electrically coupled to ground. In some implementations, a plurality of interconnects 292 may be coupled to the metal layer 390a and/or the metal layer 390b.

The metal layer 390a, the metal layer 390b, the metal layer 390c and/or other waveguide metal layers as described in the disclosure, may be configured to operate as a reflective metal layer that reflects signals 210 (e.g., beams) inside the antenna device 300, such that the signals 210 transmit and/or exit through a top portion 311 (e.g., top opening) of the antenna device 300. Thus, the metal layer 390a, the metal layer 390b, the metal layer 390c and/or other waveguide metal layers guide and/or direct the signals to emit and/or transmit in a particular direction and/or a general particular direction. Similarly, the metal layer 390a, the metal layer 390b, the metal layer 390c and/or other waveguide metal layers may guide and/or reflect signals that enter through the top portion 311 towards the antenna 201 of the antenna device 300. It is noted that the paths of the signals are exemplary. Different signals may reflect and/or travel inside the antenna device 300 differently.

In some implementations, the waveguide 309 may be considered as the antenna (e.g., waveguide antenna) for the antenna device 300. In such instances, the antenna 201 may be considered as the antenna feed for the antenna device 300. For example, in transmission mode of the antenna device 200, signals (e.g., radio frequency (RF) signals, transmitting RF signals) may travel through the plurality of interconnects 205 and the antenna 201, and is transmitted and/or feed to the waveguide 309, which radiates the signals outside of the antenna device 300. In some implementations, signals may radiate from the antenna 201 to outside of the antenna device 300 without first bouncing off of the waveguide 309. In some implementations, in reception mode and/or receiving mode, signals (e.g., RF signals, receiving RF signals) from outside of the antenna device 300 may be captured by the waveguide 309 and emitted and/or reflected towards the antenna 201, where the signals may travel through the plurality of interconnects 205. In some implementations, the antenna 201 may receive a signals that have not bounced off the waveguide 309.

Thus, as described above, in some implementations, the waveguide 309 may be considered as an antenna (e.g., waveguide antenna) for the antenna device 300, and the antenna 201 may be considered as an antenna feed for the antenna device 300. In some implementations, the antenna 201 and/or the plurality of interconnects 205 may be considered as an antenna feed for the antenna device 300. In some implementations, (i) the combination of the antenna 201 and the waveguide 309 may be considered as an antenna for the antenna device 300, and (ii) the plurality of interconnects 205 may be considered as the antenna feed for the antenna device 300.

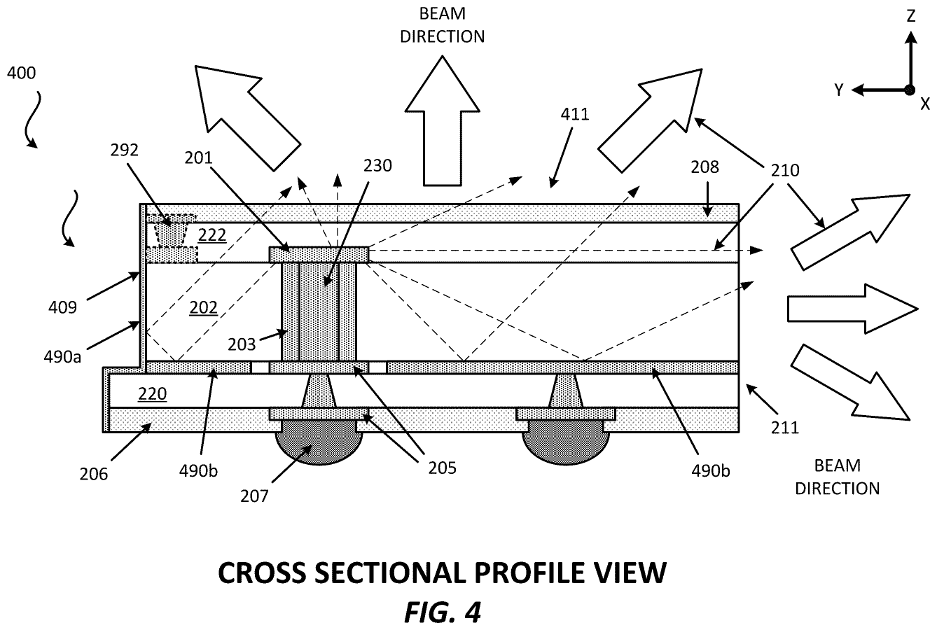

FIG. 4 illustrates an exemplary cross sectional profile view of an antenna device 400. The antenna device 400 may represent any of the antenna devices from the disclosure, such as for example, the antenna device 109a. The antenna device 400 may be similar to the antenna device 200, and may include similar components as the antenna device 200. The antenna device 400 includes an antenna 201, a core layer 202, a dielectric layer 220, a dielectric layer 222, a via interconnect 203, a plurality of interconnects 205, a solder resist layer 206, a solder resist layer 208 and a waveguide 409. The antenna device 400 may also include a plurality of solder interconnects 207.

The antenna 201 is located within the antenna device 400. The antenna 201 is coupled to at least one via interconnect 203. The at least one via interconnect 203 is located in the core layer 202. The at least one via interconnect 203 may include an inner via interconnect 230. The core layer 202 may be include a dielectric. The dielectric layer 222 is coupled to a first surface of the core layer 202. The dielectric layer 222 is coupled to a second surface of the core layer 202. The at least one via interconnect 203 is coupled to the plurality of interconnects 205. The plurality of interconnects 205 are coupled to the plurality of solder interconnects 207. The solder resist layer 206 may be coupled to the dielectric layer 220. The solder resist layer 208 may be coupled to the dielectric layer 222. In some implementations, instead of the inner via interconnect 230, a dielectric layer and/or a filler may be used. In such instances, the via interconnect 203 may laterally surround the dielectric layer and/or the filler that occupies the space and region shown as the inner via interconnect 230. The dielectric layer and/or the filler may be similar or the same as the dielectric layer 220 and/or the dielectric layer 222

The waveguide 409 may include a metal layer 490a and a metal layer 490b. The metal layer 490a and/or the metal layer 490b may be waveguide metal layers. The metal layer 490a and/or the metal layer 490b may be reflective metal layers (e.g., signal reflective metal layers). The metal layer 490a is coupled to the metal layer 490b. The metal layer 490a may be coupled to a first side surface of the antenna device 400. The metal layer 490a may be coupled to a side surface of the core layer 202, a side surface of the dielectric layer 222, a side surface of the dielectric layer 220, a side surface of the solder resist layer 206 and/or a side surface of the solder resist layer 208. The metal layer 490b may be coupled to the core layer 202. The metal layer 490b may be located between the core layer 202 and the dielectric layer 220. The metal layer 490b may touch the core layer 202 and the dielectric layer 220. The metal layer 490b may be located between the core layer 202 and the solder resist layer 206. The waveguide 409 may include other metal layers (not shown) that are formed on other side surfaces of the antenna device 400, in a similar manner as described for the metal layer 490a. For example, the waveguide 409 may include another waveguide metal layer that is coupled to a second side surface of the antenna device 400, and yet another waveguide metal layer that is coupled to a third side surface of the antenna device 400. In some implementations, the metal layer 490a, the metal layer 490b and/or other waveguide metal layers may be configured to be electrically coupled to ground.

The metal layer 490a, the metal layer 490b and/or other waveguide metal layers as described in the disclosure, may be configured to operate as a reflective metal layer that reflects signals 210 (e.g., beams) inside the antenna device 400, such that the signals 210 transmit and/or exit through a side portion 211 (e.g., side opening) and a top portion 411 (e.g., top opening) of the of the antenna device 400. Thus, the metal layer 490a, the metal layer 490b and/or other waveguide metal layers guide and/or direct the signals to emit and/or transmit in a particular direction and/or a general particular direction. Similarly, the metal layer 490a, the metal layer 490b and/or other waveguide metal layers may guide and/or reflect signals that enter through the side portion 211 and/or the top portion 411 towards the antenna 201 of the antenna device 400. It is noted that the paths of the signals are exemplary. Different signals may reflect and/or travel inside the antenna device 400 differently.

In some implementations, the waveguide 409 may be considered as the antenna for the antenna device 400. In such instances, the antenna 201 and/or the via interconnect 203 may be considered as the antenna feed for the antenna device 400. For example, in transmission mode of the antenna device 400, signals (e.g., radio frequency (RF) signals, transmitting RF signals) may travel through the plurality of interconnects 205, the via interconnect 203 and the antenna 201, and is transmitted and/or feed to the waveguide 409, which radiates the signals outside of the antenna device 400. In some implementations, signals may radiate from the via interconnect 203 and/or the antenna 201 to outside of the antenna device 400 without first bouncing off of the waveguide 409. In some implementations, in reception mode and/or receiving mode, signals (e.g., RF signals, receiving RF signals) from outside of the antenna device 400 may be captured by the waveguide 409 and emitted and/or reflected towards the antenna 201 and/or the via interconnect 203, where the signals may travel through the plurality of interconnects 205. In some implementations, the antenna 201 and/or the via interconnect 203 may receive a signals that have not bounced off the waveguide 409.

Thus, as described above, in some implementations, the waveguide 409 may be considered as an antenna for the antenna device 400, and the antenna 201 may be considered as an antenna feed for the antenna device 400. In some implementations, the antenna 201, the via interconnect 203 and/or the plurality of interconnects 205 may be considered as an antenna feed for the antenna device 400. In some implementations, (i) the combination of the antenna 201 and the waveguide 409 may be considered as an antenna for the antenna device 400, and (ii) the via interconnect 203 and/or the plurality of interconnects 205 may be considered as the antenna feed for the antenna device 400.

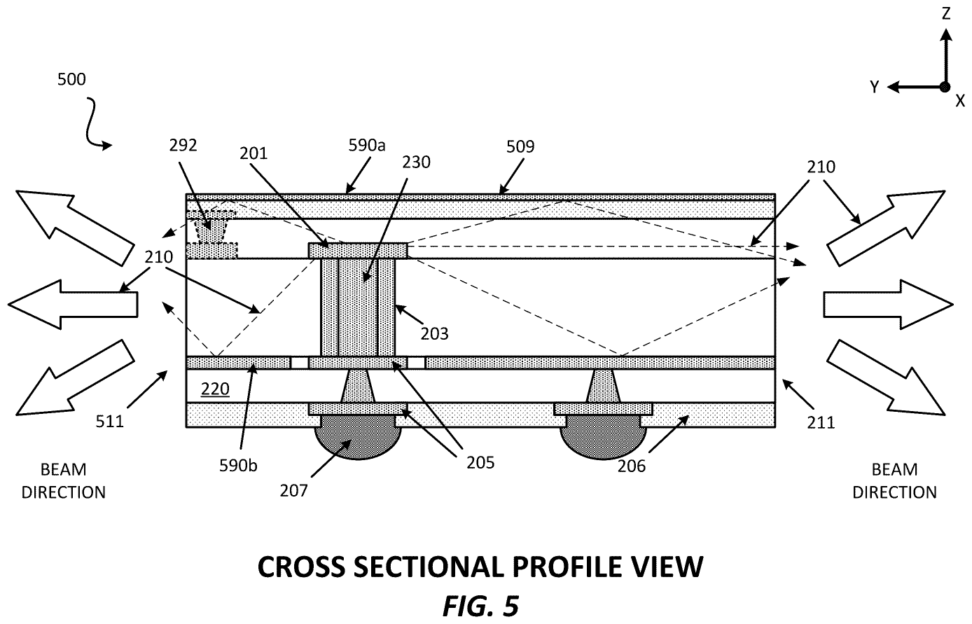

FIG. 5 illustrates an angled view of an antenna device 500. The antenna device 500 may represent any of the antenna devices from the disclosure, such as for example, the antenna device 109a. The antenna device 500 includes an antenna 201, a dielectric layer 202, a dielectric layer 220, a dielectric layer 222, a via interconnect 203, a plurality of interconnects 205, a solder resist layer 206, a solder resist layer 208 and a waveguide 509. The antenna device 500 may also include a plurality of solder interconnects 207.

The antenna 201 is located within the antenna device 500. The antenna 201 is coupled to at least one via interconnect 203. The at least one via interconnect 203 is located in the core layer 202. The at least one via interconnect 203 may include an inner via interconnect 230. The core layer 202 may be include a dielectric. The dielectric layer 222 is coupled to a first surface of the core layer 202. The dielectric layer 222 is coupled to a second surface of the core layer 202. The at least one via interconnect 203 is coupled to the plurality of interconnects 205. The plurality of interconnects 205 are coupled to the plurality of solder interconnects 207. The solder resist layer 206 may be coupled to the dielectric layer 220. The solder resist layer 208 may be coupled to the dielectric layer 222. In some implementations, instead of the inner via interconnect 230, a dielectric layer and/or a filler may be used. In such instances, the via interconnect 203 may laterally surround the dielectric layer and/or the filler that occupies the space and region shown as the inner via interconnect 230. The dielectric layer and/or the filler may be similar or the same as the dielectric layer 220 and/or the dielectric layer 222

The waveguide 509 may form a partial enclosure that partially encloses and/or surrounds the antenna 201. The waveguide 509 may include a metal layer 590a and a metal layer 590b. The metal layer 590a and/or the metal layer 590b may be waveguide metal layers. The metal layer 590a and/or the metal layer 590b may be reflective metal layers (e.g., signal reflective metal layers). The metal layer 590a may be coupled to the metal layer 590b through other metal layers (not shown). The metal layer 590a may be coupled to a first horizontal surface of the antenna device 500. For example, the metal layer 590a may be coupled to a top horizontal surface of the antenna device 500. The metal layer 590a may be coupled to the solder resist layer 208. The metal layer 590b may be coupled to the core layer 202. The metal layer 590b may be located between the core layer 202 and the dielectric layer 220. The metal layer 590b may touch the core layer 202 and the dielectric layer 220. The metal layer 590b may be located between the core layer 202 and the solder resist layer 206. The waveguide 509 may include other metal layers (not shown) that are formed on other side surfaces of the antenna device 500. For example, the waveguide 509 may include another waveguide metal layer that is coupled to a first side surface of the antenna device 500, and yet another waveguide metal layer that is coupled to a second side surface of the antenna device 500. In some implementations, the metal layer 590a the metal layer 590b and/or other waveguide metal layers may be configured to be electrically coupled to ground. In some implementations, a plurality of interconnects 292 may be coupled to different metal layers.

The metal layer 590a, the metal layer 590b and/or other waveguide metal layers as described in the disclosure, may be configured to operate as a reflective metal layer that reflects signals 210 (e.g., beams) inside the antenna device 500, such that the signals 210 transmit and/or exit through a side portion 211 (e.g., side opening) and/or a side portion 511 of the antenna device 500. Thus, the metal layer 590a, the metal layer 590b and/or other waveguide metal layers guide and/or direct the signals to emit and/or transmit in a particular direction and/or a general particular direction. Similarly, the metal layer 590a, the metal layer 590b and/or other waveguide metal layers may guide and/or reflect signals that enter through the side portion 211 and/or the side portion 511 towards the antenna 201 of the antenna device 500. It is noted that the paths of the signals are exemplary. Different signals may reflect and/or travel inside the antenna device 500 differently.

In some implementations, the waveguide 509 may be considered as the antenna for the antenna device 500. In such instances, the antenna 201 and/or the via interconnect 203 may be considered as the antenna feed for the antenna device 500. For example, in transmission mode of the antenna device 500, signals (e.g., radio frequency (RF) signals, transmitting RF signals) may travel through the plurality of interconnects 205, the via interconnect 203 and the antenna 201, and is transmitted and/or feed to the waveguide 509, which radiates the signals outside of the antenna device 500. In some implementations, signals may radiate from the via interconnect 203 and/or the antenna 201 to outside of the antenna device 500 without first bouncing off of the waveguide 509. In some implementations, in reception mode and/or receiving mode, signals (e.g., RF signals, receiving RF signals) from outside of the antenna device 500 may be captured by the waveguide 509 and emitted and/or reflected towards the antenna 201 and/or the via interconnect 203, where the signals may travel through the plurality of interconnects 205. In some implementations, the antenna 201 and/or the via interconnect 203 may receive a signals that have not bounced off the waveguide 509.

Thus, as described above, in some implementations, the waveguide 509 may be considered as an antenna (e.g., waveguide antenna) for the antenna device 500, and the antenna 201 may be considered as an antenna feed for the antenna device 500. In some implementations, the antenna 201, the via interconnect 203 and/or the plurality of interconnects 205 may be considered as an antenna feed for the antenna device 500. In some implementations, (i) the combination of the antenna 201 and the waveguide 509 may be considered as an antenna for the antenna device 500, and (ii) the via interconnect 203 and/or the plurality of interconnects 205 may be considered as the antenna feed for the antenna device 500.

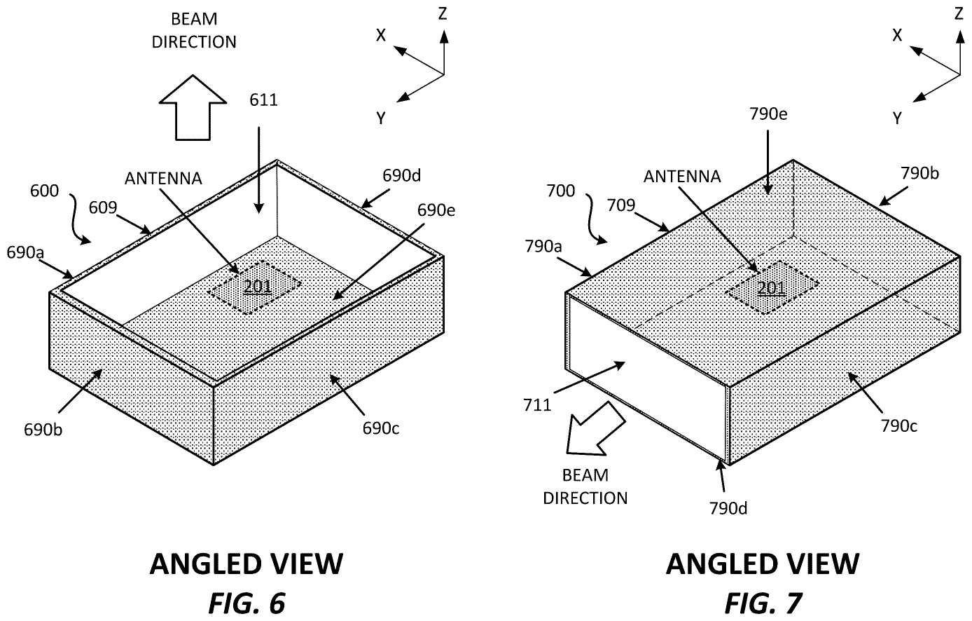

FIG. 6 illustrates a conceptual representation of an antenna device 600. The antenna device 600 may represent any of the antenna devices described in the disclosure. The antenna device 600 includes a waveguide 609. The waveguide 609 includes a metal layer 690a, a metal layer 690b, a metal layer 690c, a metal layer 690d and a metal layer 690e. The metal layer 690e may be a bottom metal layer of the antenna device 600. The metal layer 690a, the metal layer 690b, the metal layer 690c and the metal layer 690d may be located on side portions and/or side surfaces of the antenna device 600. Signals may emit from the antenna 201 and exit the antenna device 600 through a top portion 611 and/or a top opening of the antenna device 600. The waveguide 609 may form a partial enclosure that partially encloses the antenna 201. In some implementations, the antenna 201 may be planar and/or co-planar with the metal layer 690e. In some implementations, the waveguide 609 may include a waveguide antenna and the antenna 201 may include an antenna feed.

FIG. 7 illustrates a conceptual representation of an antenna device 700. The antenna device 700 may represent any of the antenna devices described in the disclosure. The antenna device 700 includes a waveguide 709. The waveguide 709 includes a metal layer 790a, a metal layer 790b, a metal layer 790c, a metal layer 790d and a metal layer 790e. The metal layer 790d may be a bottom metal layer of the antenna device 700. The metal layer 790e may be a top metal layer of the antenna device 700. The metal layer 790a, the metal layer 790b and the metal layer 790c may be located on side portions and/or side surfaces of the antenna device 700. Signals may emit from the antenna 201 and exit the antenna device 700 through a side portion 711 and/or a side opening of the antenna device 700. The waveguide 709 may form a partial enclosure that partially encloses the antenna 201. In some implementations, the waveguide 709 may include a waveguide antenna and the antenna 201 may include an antenna feed.

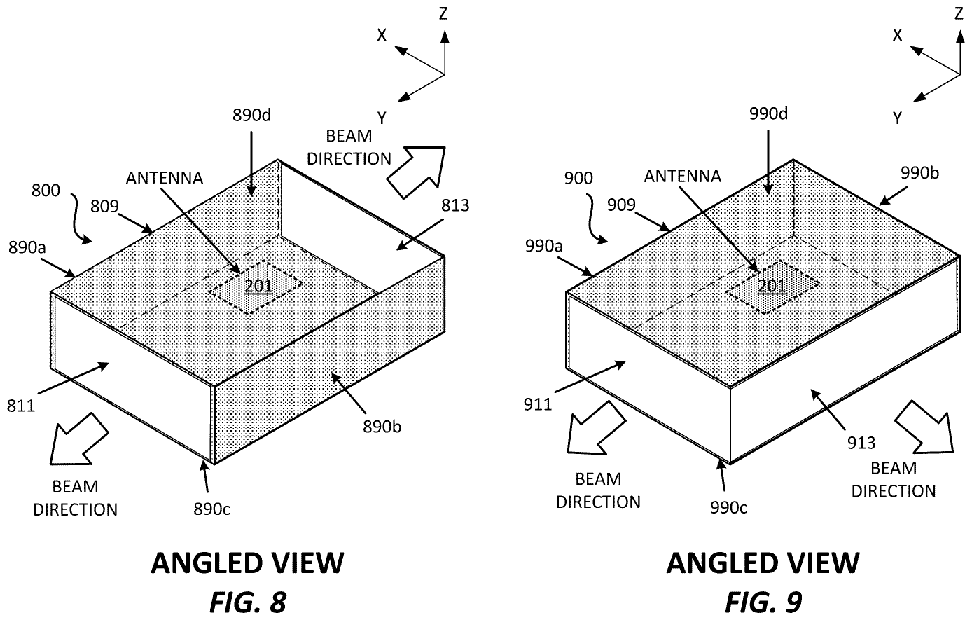

FIG. 8 illustrates a conceptual representation of an antenna device 800. The antenna device 800 may represent any of the antenna devices described in the disclosure. The antenna device 800 includes a waveguide 809. The waveguide 809 includes a metal layer 890a, a metal layer 890b, a metal layer 890c and a metal layer 890d. The metal layer 890c may be a bottom metal layer of the antenna device 800. The metal layer 890d may be a top metal layer of the antenna device 800. The metal layer 890a and the metal layer 890b may be located on side portions and/or side surfaces of the antenna device 800. Signals may emit from the antenna 201 and exit the antenna device 800 through a side portion 811, a side surface 813 and/or side opening(s) of the antenna device 800. The waveguide 809 may form a partial enclosure that partially encloses the antenna 201. In some implementations, the waveguide 809 may include a waveguide antenna and the antenna 201 may include an antenna feed.

FIG. 9 illustrates a conceptual representation of an antenna device 900. The antenna device 900 may represent any of the antenna devices described in the disclosure. The antenna device 900 includes a waveguide 909. The waveguide 909 includes a metal layer 990a, a metal layer 990b, a metal layer 990c and a metal layer 990d. The metal layer 990c may be a bottom metal layer of the antenna device 900. The metal layer 990d may be a top metal layer of the antenna device 900. The metal layer 990a and the metal layer 990b may be located on side portions and/or side surfaces of the antenna device 900. Signals may emit from the antenna 201 and exit the antenna device 900 through a side portion 911, a side surface 913 and/or side opening(s) of the antenna device 900. The waveguide 909 may form a partial enclosure that partially encloses the antenna 201. In some implementations, the waveguide 909 may include a waveguide antenna and the antenna 201 may include an antenna feed.

It is noted that the signals and/or beam directions shown in FIGS. 1-9 and/or any other figures in the disclosure, illustrate exemplary directions of signals and/or beams that are transmitted. In some implementations, signals and/or beams that are received may travel in the opposite directions that are shown in FIGS. 1-9 and/or any other figures in the disclosure. Thus, when an antenna device is in receiving mode, signals and/or beams may be reflected off the waveguide (e.g., waveguide antenna) and directed towards the antenna and/or the antenna feed. One or more openings in the waveguide and/or the waveguide antenna may mean that particular side, that particular portion, and/or that particular surface is not occupied with a metal layer that is part of the waveguide and/or the waveguide antenna. The waveguides (e.g., 209, 309, 409, 509, 609, 709, 809, 909) described in the disclosure may be a waveguide antenna and/or a waveguide antenna enclosure. The waveguide antenna enclosure may include one or more sides that are configured as openings in the waveguide antenna enclosure, through which signals and/or beams may enter and/or exit. In some implementations, the walls (e.g., inner walls) and/or surfaces (e.g., inner surfaces) of the waveguides may be perpendicular to each other. In some implementations, the walls (e.g., inner walls) and/or surfaces (e.g., inner surfaces) of the waveguides may be positioned at different angles relative to each other (e.g.., angles less than 90 degrees, angles more than 90 degrees).

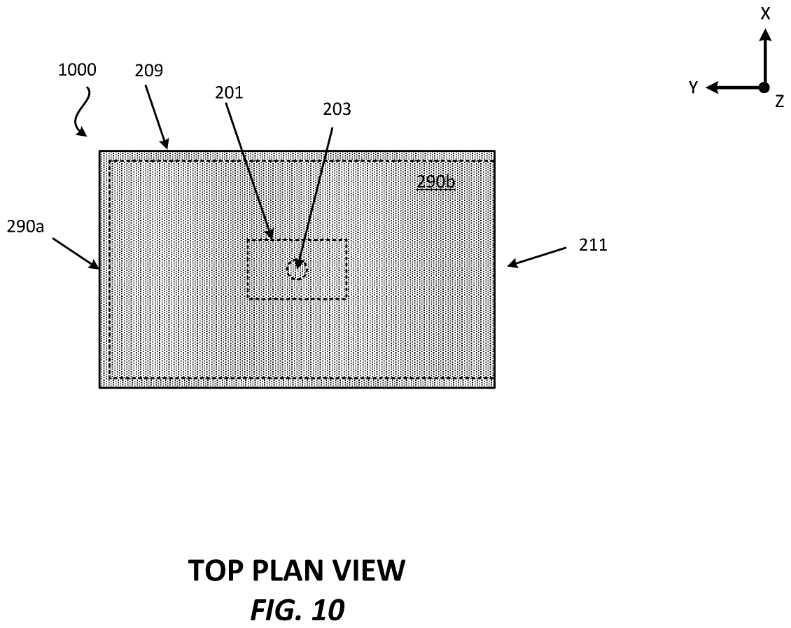

FIG. 10 illustrates a cross sectional plan view of the antenna device 1000. The antenna device 1000 includes the antenna 201, the at least one via interconnect 203, the metal layer 290a and the metal layer 290b. The metal layer 290a and the metal layer 290b may be part of a waveguide for the antenna device 1000. The antenna device 1000 may represent any of the antenna devices described in the disclosure. The antenna device 1000 includes a side portion 211 that is an opening in the waveguide 209, where signals may enter and/or exit. The waveguide 209 may form a partial enclosure with a top planar surface (e.g., along X-Y plane), a bottom planar surface (e.g., along X-Y plane), a first lateral surface (e.g., along X-Z plane, along Y-Z plane), a second lateral surface (e.g., along X-Z plane, along Y-Z plane) and/or a third lateral surface (e.g., along X-Z plane, along Y-Z plane).

In some implementations, the planar surface(s), side surface(s) and/or the lateral surface(s) of the waveguides (e.g., 209, 309, 409, 509, 609, 709, 809, 909) in the disclosure may cover all or substantially all of the surface(s) of the antenna device that are not configured to be openings for the waveguide(s). A particular surface (e.g.,. side surface, lateral surface, planar surface) of an antenna device that is substantially covered by the waveguide may mean that at least 90 percent of that particular surface is covered by a waveguide metal layer of the waveguide.

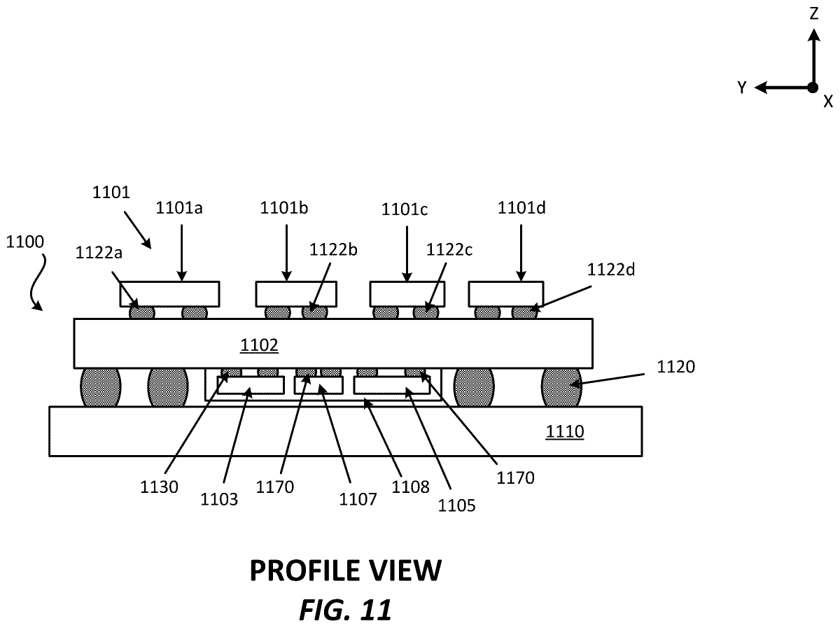

FIG. 11 illustrates an exemplary cross sectional profile view of the package 1100 comprising a plurality of antenna devices. The package 1100 is coupled to a substrate 1110 through a plurality of solder interconnects 1120. The package 1100 includes a package substrate 1102 and a plurality of antenna devices 1101. The package substrate 1102 may be an package interposer. The package substrate 1102 may be laminated substrate. The plurality of antenna devices 1101 may include an antenna device 1101a, an antenna device 1101b, an antenna device 1101c and an antenna device 1101d. The plurality of antenna devices 1101 may include any of the antenna devices described in the disclosure. The antenna device 1101a may be coupled to the package substrate 1102 through a plurality of solder interconnects 1122a. The antenna device 1101b may be coupled to the package substrate 1102 through a plurality of solder interconnects 1122b. The antenna device 1101c may be coupled to the package substrate 1102 through a plurality of solder interconnects 1122c. The antenna device 1101d may be coupled to the package substrate 1102 through a plurality of solder interconnects 1122d.

FIG. 11 also illustrates that the package 1100 may include an integrated device 1103, an integrated device 1105, a passive device 1107 and an encapsulation layer 1108. The integrated device 1103 may be coupled to a bottom surface of the package substrate 1102 through a plurality of solder interconnects 1130. The integrated device 1105 may be coupled to a bottom surface of the package substrate 1102 through a plurality of solder interconnects 1150. The passive device 1107 may be coupled to a bottom surface of the package substrate 1102 through a plurality of solder interconnects 1170. The encapsulation layer 1108 may be coupled to the bottom surface of the package substrate 1102. The encapsulation layer 1108 may at least partially encapsulate the integrated device 1103, the integrated device 1105 and/or the passive device 1107. In some implementations, the integrated device 1103 may include an integrated device configured for radio frequency transmission and receiving. In some implementations, the integrated device 1105 may include an integrated device configured for power management. In some implementations, the passive device 1107 may include a capacitor.

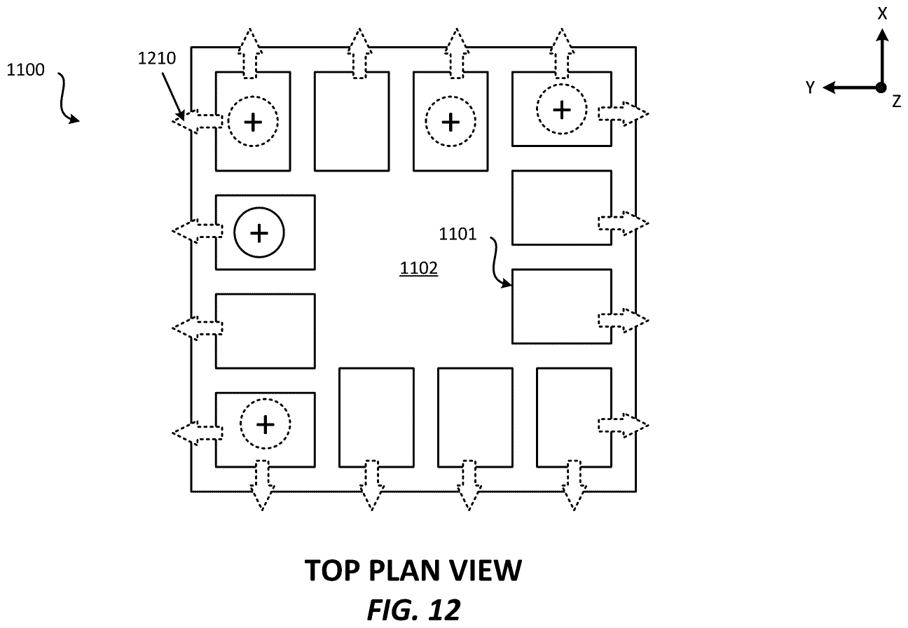

FIG. 12 illustrates an exemplary cross section plan view of the package 1100. The package 1100 includes a package substrate 1102 and a plurality of antenna devices 1101. FIG. 12 illustrates exemplary directions for which the waveguides of the antenna devices are configured to transmit and/or receive signals 1210. The “+” signs in FIG. 12 indicate that the signals may be transmitted and/or received in the Z direction.

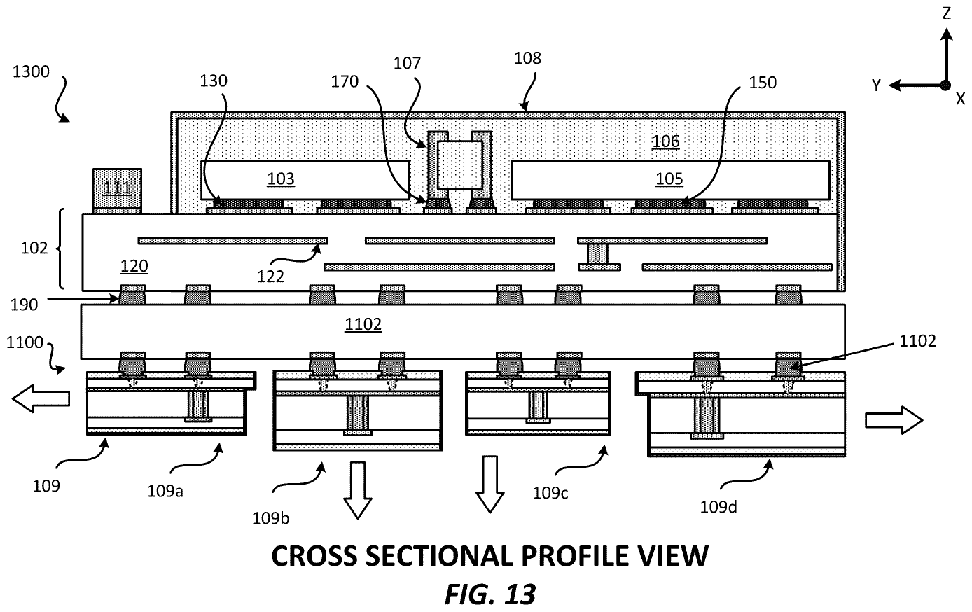

FIG. 13 illustrates a profile view of a package 1300 that includes an antenna device with a wave guide. The package 1300 may be an antenna package. The package 1300 includes a substrate 102, an integrated device 103, an integrated device 105, a passive device 107, an encapsulation layer 106, a shield 108, a package 1100 and a connector 111. The package 1100 includes the package substrate 1102 and the plurality of antenna devices 109. One or more antenna devices from the plurality of antenna devices 109, may include a waveguide. The plurality of antenna devices 109 may be coupled to the package substrate 1102 through a plurality of solder interconnects 1102.

The package 1300 may be similar to the package 100 of FIG. 1, and may include similar components that are arranged in a similar manner as described for the package 100. The package substrate 1102 may be coupled to a bottom surface of the substrate 102 through a plurality of solder interconnects 190.

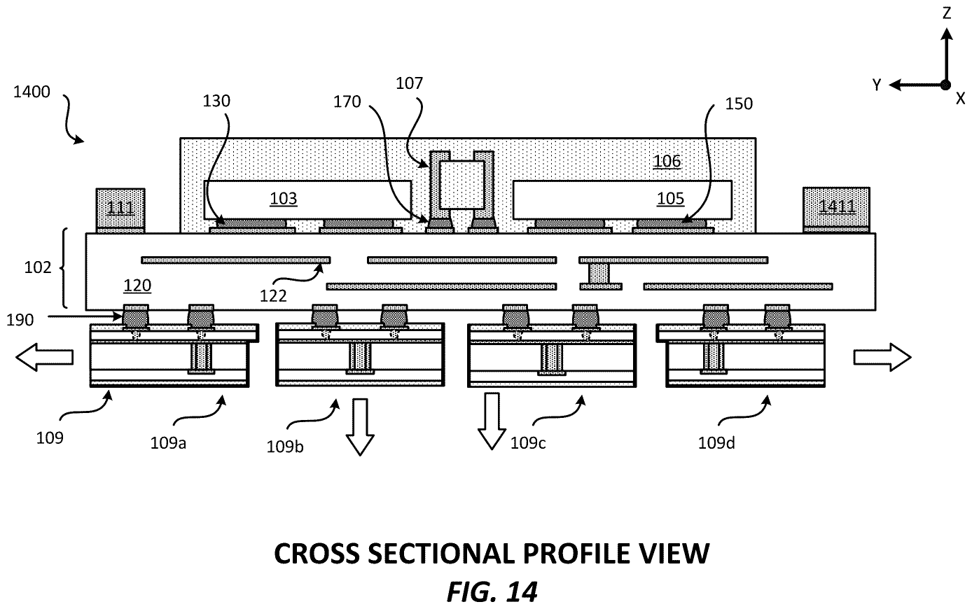

FIG. 14 illustrates a profile view of a package 1400 that includes an antenna device with a waveguide. The package 1400 may be an antenna package. The package 1400 includes a substrate 102, an integrated device 103, an integrated device 105, a passive device 107, an encapsulation layer 106, a shield 108, a plurality of antenna devices 109, a connector 111 and a connector 1411. One or more antenna devices from the plurality of antenna devices 109, include a waveguide.

The package 1400 is similar to the package 100, and includes similar and/or the same components as the package 100, and are arranged in a similar manner as the package 100. The package 1400 includes two connectors (e.g., connector 1111 and connector 1411) and antenna devices arranged in an array. The connector 1411 is similar to the connector 111. In some implementations, the connector 111 may be configured to be electrically coupled to a first set of antenna devices from the plurality of antenna devices 109, and the connector 1411 may be configured to be electrically coupled to a second set of antenna devices from the plurality of antenna devices 109.

The connector 1411 is configured to provide electrical paths for millimeter wave signals. The connector 1411 may include interconnects configured as coaxial interconnects. A connector 1411 may include a plurality of pins (not shown). The plurality of pins may be configured to provide electrical paths for power, ground and signals (e.g., millimeter wave signals). The connector 1411 may be configured to be electrically coupled to the integrated device 103, the integrated device 105 and/or the plurality of antenna devices 109, through the substrate 102. A cable (not shown) may be coupled to the connector 1411. The cable (not show) may be configured to be coupled to a board (e.g., printed circuit board).

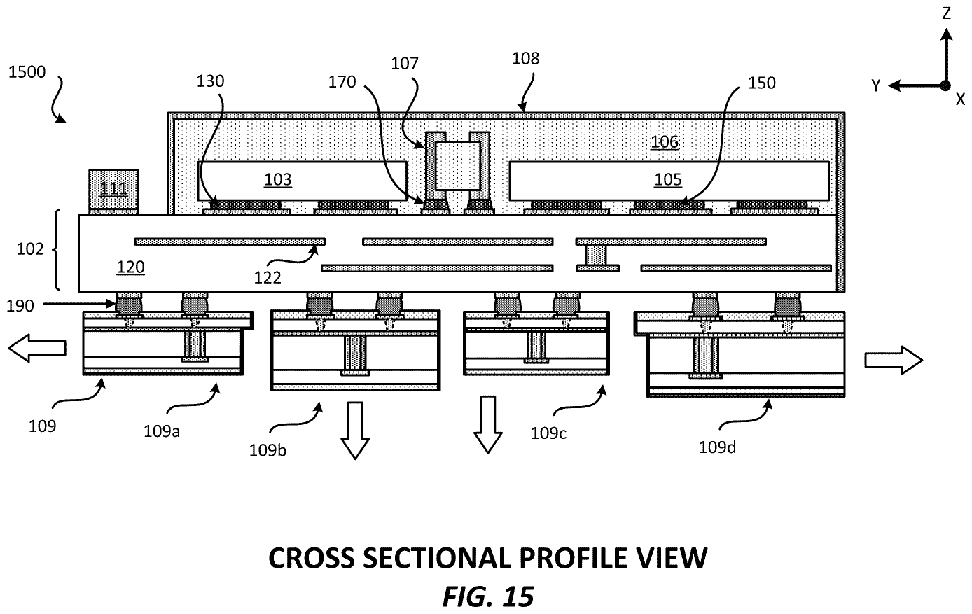

FIG. 15 illustrates a profile view of a package 1500 that includes an antenna device with a wave guide. The package 1500 may be an antenna package. The package 1500 includes a substrate 102, an integrated device 103, an integrated device 105, a passive device 107, an encapsulation layer 106, a shield 108, a connector 111 and a plurality of antenna devices 109.

The package 1500 may be similar to the package 100 of FIG. 1, and may include similar components that are arranged in a similar manner as described for the package 100. FIG. 15 illustrates that the plurality of antenna devices 109 may include antenna devices with different sizes, shapes and/or thicknesses.

The antenna devices may be oriented in a same direction. However, in some implementations, one or more antenna devices may be oriented and/or angled in different directions. Different antenna devices may have different sizes and/shapes. Different antenna devices may have different numbers of antennas. Different antenna devices may have different shapes for their antennas.

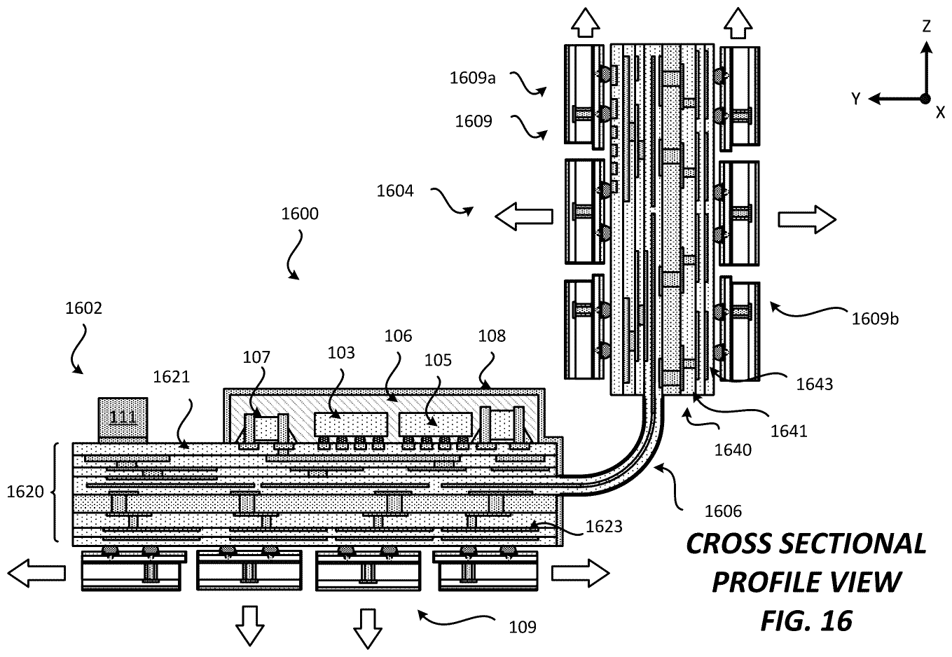

FIG. 16 illustrates a profile view of a package device 1600 that includes a package 1602, a package 1604, and a flexible connection 1606. As will be further described below, the package device 1600 includes multi-directional antennas that help improve the performance of the package device 1600.

The package 1602 (e.g., first package) includes a substrate 1620 (e.g., first substrate), one or more integrated devices (e.g., 103, 105), one or more passive devices (e.g., 107), an encapsulation layer 106, a shield 108, a plurality of antenna devices 109 and a connector 111. The substrate 1620 includes one or more dielectric layers 1621 and a plurality of interconnects 1623. The plurality of antenna devices 109 may be coupled to a surface of the substrate 1620 through at least a plurality of solder interconnects.

The package 1604 (e.g., second package) includes a substrate 1640 (e.g., second substrate) and a plurality of antenna devices 1609. The substrate 1640 includes one or more dielectric layers 1641 and a plurality of interconnects 1643. The plurality of antenna devices 1609 include a plurality of antenna devices 1609a and a plurality of antenna devices 1609b. The plurality of antenna devices 1609a may be coupled to a first surface of the substrate 1640. The plurality of antenna devices 1609b may be coupled to a second surface of the substrate 1640.

The package 1602 is coupled to the package 1604 though the flexible connection 1606. Thus, the flexible connection 1606 may be coupled to the package 1602 (e.g., first package) and the package 1604 (e.g., second package). The flexible connection 1606 may be embedded in the package 1602 and the package 1604. The flexible connection 1606 includes at least one dielectric layer and at least one interconnect. The at least one dielectric layer may include polyimide or liquid crystal polymer. The flexible connection 1606 may be configured to electrically couple the package 1602 and the package 1604. The flexible connection 1606 may be configured to allow different currents (e.g., signal, power, ground) to travel between the package 1602 and the package 1604. For example, the flexible connection 1606 may include (i) at least one first interconnect configured for a signal (e.g., input/output signal), (ii) at least one second interconnect configured for power, and (iii) at least one third interconnect configured for ground. The flexible connection 1606 is bendable such that the package 1604 may be positioned at an angle to the package 1602, and vice versa. The flexible connection 1606 may be means for flexible connection. Although not shown, the flexible connection 1606 may include a cover protective material or be covered with a protective material. In at least some implementations, the flexible connection 1606 may be configured to be bendable up to 180 degrees without fracturing. Thus, for example, components of the flexible connection 1606, such as the at least one dielectric layer and the at least one interconnect, may bend up to 180 degrees without causing damage, a crack and/or a fracture in the flexible connection 1606. Various implementations of the flexible connection 1606 may be bendable up to different degrees. For example, in at least some implementations, the flexible connection 1606 may be configured to be bendable up to 90 degrees without fracturing and/or cracking. In at least some implementations, the flexible connection 1606 may be configured to be bendable by at least 10 degrees (or more) without fracturing and/or cracking. The term “flexible” may mean that a component is (i) bendable by at least 10 degrees (or more) without fracturing and/or cracking, and/or (ii) bendable up to 180 degrees without fracturing and/or cracking.

An electrical path between an antenna device from the plurality of antenna devices 1609 and an integrated device (e.g., 103, 105) may include solder interconnects between the plurality of antenna devices (e.g., 1609a) and the substrate 1640, interconnects from the substrate 1640, interconnects from the flexible connection 1606, interconnects from the substrate 1620 and a solder interconnect from a plurality of solder interconnects between an integrated device and the substrate 1620.

An electrical path between an antenna device from the plurality of antenna devices 109 and an integrated device (e.g., 103, 105) may include solder interconnects between the antenna device (e.g., 109a) and the substrate 1620, interconnects from the substrate 1620 and a solder interconnect from a plurality of solder interconnects between an integrated device and the substrate 1620.

An electrical path between the connector 111 and an integrated device (e.g., 103, 105) may include interconnects from the substrate 1620, and a solder interconnect from a plurality of solder interconnects between an integrated device and the substrate 1620.

The package (e.g., 100) may be implemented in a radio frequency (RF) package. The RF package may be a radio frequency front end (RFFE) package. A package (e.g., 100) may be configured to provide Wireless Fidelity (WiFi) communication and/or cellular communication (e.g., 2G, 3G, 4G, 5G, 6G). The packages (e.g., 100) may be configured to support Global System for Mobile (GSM) Communications, Universal Mobile Telecommunications System (UMTS), and/or Long-Term Evolution (LTE). The packages (e.g., 100) may be configured to transmit and receive signals having different frequencies and/or communication protocols.

An integrated device (e.g., 105) may include a die (e.g., semiconductor bare die). The integrated device may include a power management integrated circuit (PMIC). The integrated device may include an application processor. The integrated device may include a modem. The integrated device may include a radio frequency (RF) device, a passive device, a filter, a capacitor, an inductor, an antenna, a transmitter, a receiver, a gallium arsenide (GaAs) based integrated device, a surface acoustic wave (SAW) filter, a bulk acoustic wave (BAW) filter, a light emitting diode (LED) integrated device, a silicon (Si) based integrated device, a silicon carbide (SiC) based integrated device, a memory, power management processor, and/or combinations thereof. An integrated device may include at least one electronic circuit (e.g., first electronic circuit, second electronic circuit, etc . . . ). An integrated device may include an input/output (I/O) hub. An integrated device may include transistors. An integrated device may be an example of an electrical component and/or electrical device.

In some implementations, an integrated device may be a chiplet. A chiplet may be fabricated using a process that provides better yields compared to other processes used to fabricate other types of integrated devices, which can lower the overall cost of fabricating a chiplet. Different chiplets may have different sizes and/or shapes. Different chiplets may be configured to provide different functions. Different chiplets may have different interconnect densities (e.g., interconnects with different width and/or spacing). In some implementations, several chiplets may be used to perform the functionalities of one or more chips (e.g., one or more integrated devices). As mentioned above, using several chiplets that perform several functions may reduce the overall cost of a package relative to using a single chip to perform all of the functions of a package. In some implementations, one or more of the chiplets and/or one of more of integrated devices (e.g., 105) described in the disclosure may be fabricated using the same technology node or two or more different technology nodes. For example, an integrated device may be fabricated using a first technology node, and a chiplet may be fabricated using a second technology node that is not as advanced as the first technology node. In such an example, the integrated device may include components (e.g., interconnects, transistors) that have a first minimum size, and the chiplet may include components (e.g., interconnects, transistors) that have a second minimum size, where the second minimum size is greater than the first minimum size. In some implementations, a first integrated device and a second integrated device of a package, may be fabricated using the same technology node or different technology nodes. In some implementations, a chiplet and another chiplet of a package, may be fabricated using the same technology node or different technology nodes.

A technology node may refer to a specific fabrication process and/or technology that is used to fabricate an integrated device and/or a chiplet. A technology node may specify the smallest possible size (e.g., minimum size) that can be fabricated (e.g., size of a transistor, width of trace, gap width between two transistors). Different technology nodes may have different yield loss. Different technology nodes may have different costs. Technology nodes that produce components (e.g., trace, transistors) with fine details are more expensive and may have higher yield loss, than a technology node that produces components (e.g., trace, transistors) with details that are less fine. Thus, more advanced technology nodes may be more expensive and may have higher yield loss, than less advanced technology nodes. When all of the functions of a package are implemented in single integrated devices, the same technology node is used to fabricate the entire integrated device, even if some of the functions of the integrated devices do not need to be fabricated using that particular technology node. Thus, the integrated device is locked into one technology node. To optimize the cost of a package, some of the functions can be implemented in different integrated devices and/or chiplets, where different integrated devices and/or chiplets may be fabricated using different technology nodes to reduce overall costs. For example, functions that require the use of the most advanced technology node may be implemented in an integrated device, and functions that can be implemented using a less advanced technology node can be implemented in another integrated device and/or one or more chiplets. One example, would be an integrated device, fabricated using a first technology node (e.g., most advanced technology node), that is configured to provide compute applications, and at least one chiplet, that is fabricated using a second technology node, that is configured to provide other functionalities, where the second technology node is not as costly as the first technology node, and where the second technology node fabricates components with minimum sizes that are greater than the minimum sizes of components fabricated using the first technology node. Examples of compute applications may include high performance computing and/or high performance processing, which may be achieved by fabricating and packing in as many transistors as possible in an integrated device, which is why an integrated device that is configured for compute applications may be fabricated using the most advanced technology node available, while other chiplets may be fabricated using less advanced technology nodes, since those chiplets may not require as many transistors to be fabricated in the chiplets. Thus, the combination of using different technology nodes (which may have different associated yield loss) for different integrated devices and/or chiplets, can reduce the overall cost of a package, compared to using a single integrated device to perform all the functions of the package.

Another advantage of splitting the functions into several integrated devices and/or chiplets, is that it allows improvements in the performance of the package without having to redesign every single integrated device and/or chiplet. For example, if a configuration of a package uses a first integrated device and a first chiplet, it may be possible to improve the performance of the package by changing the design of the first integrated device, while keeping the design of the first chiplet the same. Thus, the first chiplet could be reused with the improved and/or different configured first integrated device. This saves cost by not having to redesign the first chiplet, when packages with improved integrated devices are fabricated.

### Exemplary Sequence for Fabricating an Antenna Device

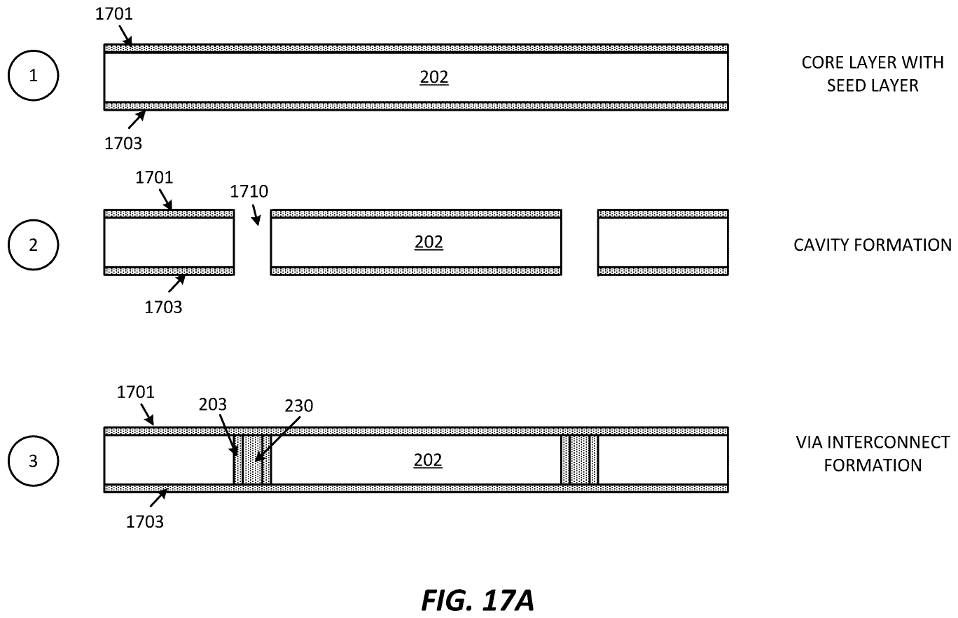

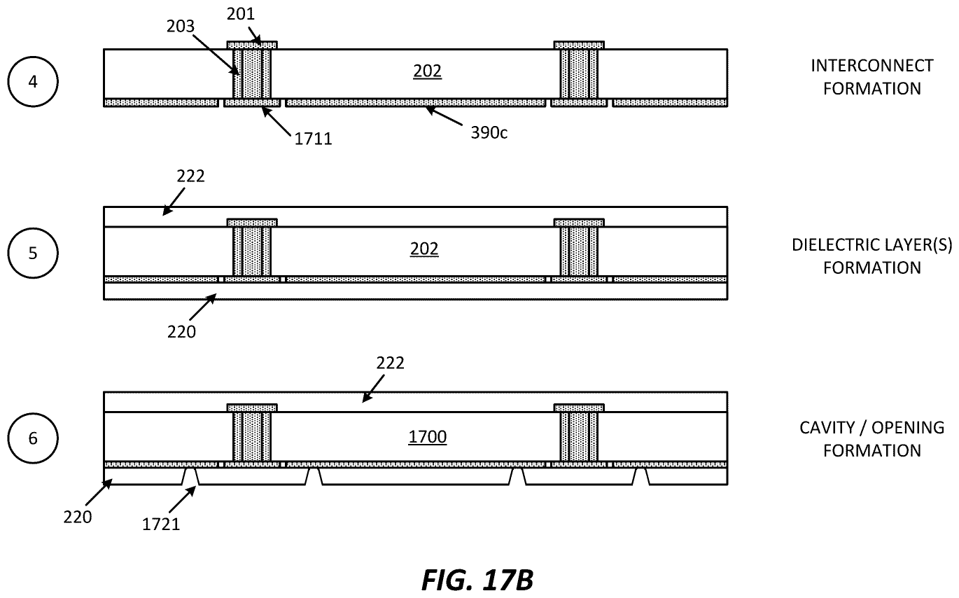

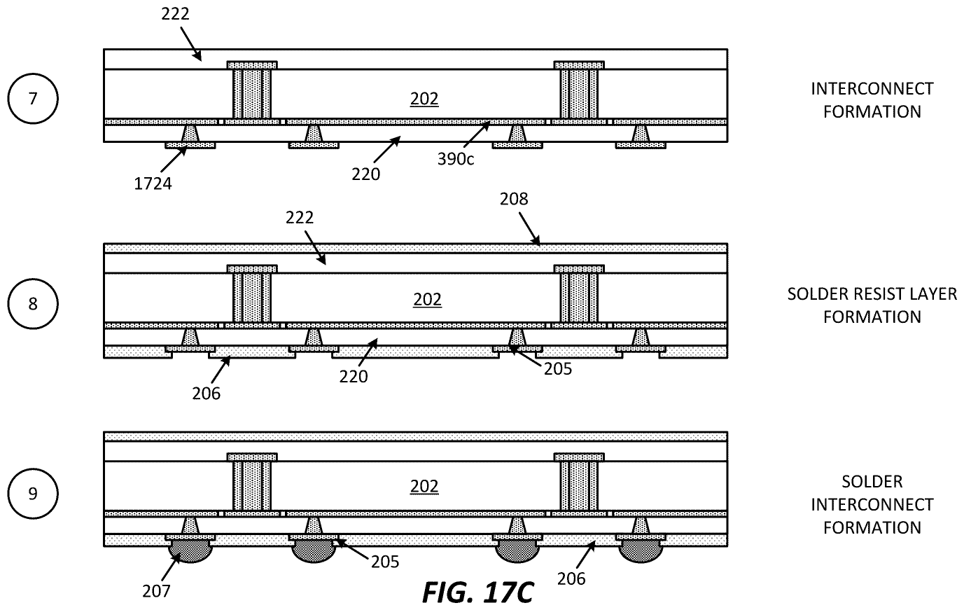

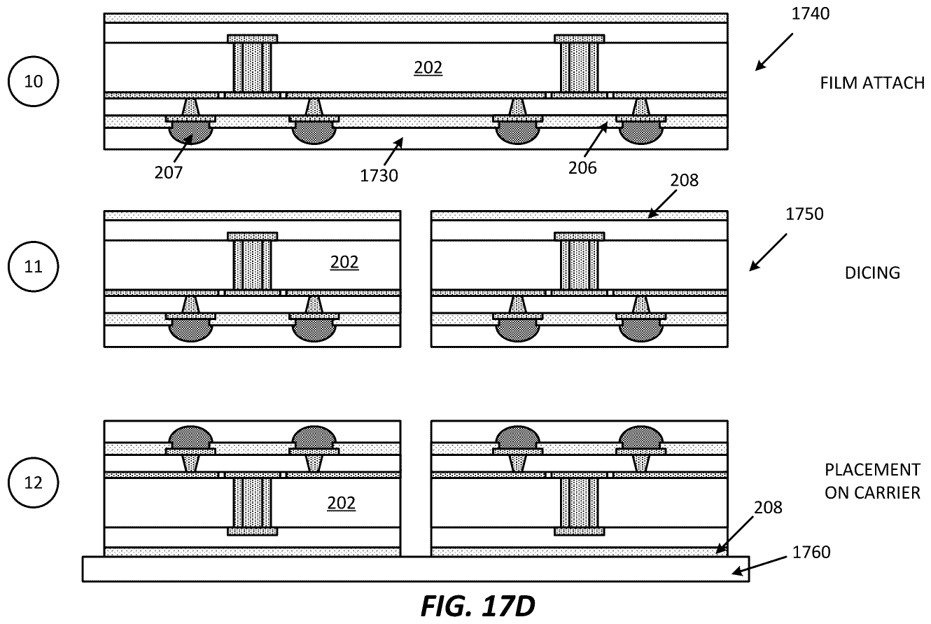

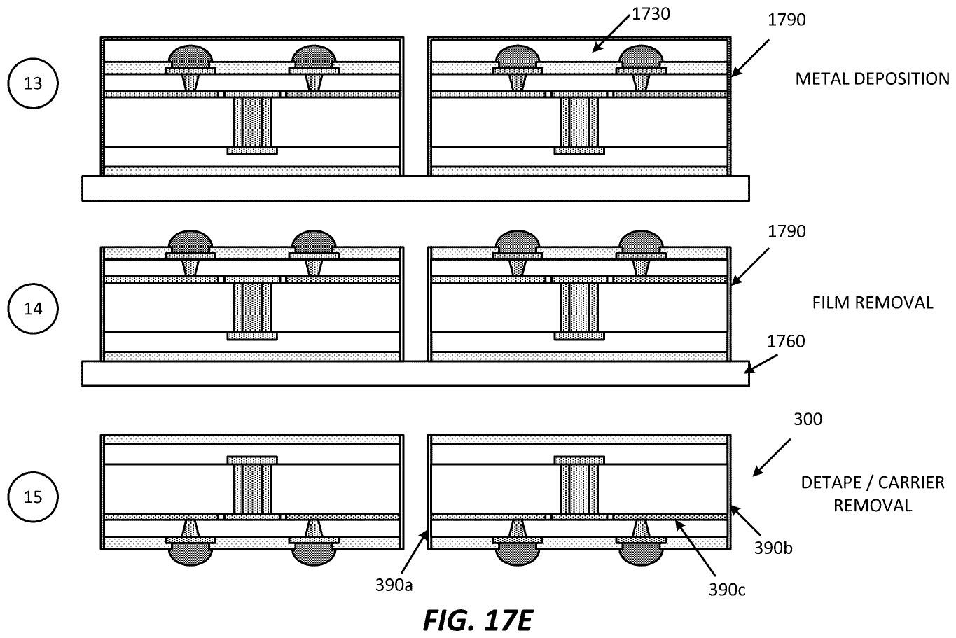

FIGS. 17A-17E illustrate an exemplary sequence for providing or fabricating an antenna device. In some implementations, the sequence of FIGS. 17A-17E may be used to provide or fabricate any of the substrates described in the disclosure. In some implementations, the sequence of FIGS. 17A-17E may be used to provide or fabricate the antenna device (e.g., 300) described in the disclosure. However, the sequence of FIGS. 17A-17E may be used to fabricate any antenna device described by the disclosure.

It should be noted that the sequence of FIGS. 17A-17E may combine one or more stages in order to simplify and/or clarify the sequence for providing or fabricating an antenna device. In some implementations, the order of the processes may be changed or modified. In some implementations, one or more of processes may be replaced or substituted without departing from the spirit of the disclosure. Different implementations may fabricate a substrate differently.

Stage 1, as shown in FIG. 17A, illustrates a state after a core layer 202, a seed layer 1701 and a seed layer 1702 are provided. The core layer 202 may include a dielectric layer. The seed layer 1701 and/or the seed layer 1702 may include copper.

Stage 2 illustrates a state after a plurality of cavities 1710 are formed through the core layer 202, the seed layer 1701 and/or the seed layer 1703 are formed. A laser process (e.g., laser ablation) may be used to form the plurality of cavities 1710.

Stage 3 illustrates a state after a plurality of via interconnects 203 are formed in the plurality of cavities 1710 of the core layer 202. The plurality of via interconnects 203 may include inner via interconnects 230. A plating process may be used to form the via interconnects 203. The inner via interconnects 230 may be considered part of the via interconnects 203. In some implementations, instead of the inner via interconnects 230, a dielectric layer and/or a filler may be used. In such instances, the via interconnects 203 may be formed, and the dielectric layer and/or the filler may be formed in the plurality of cavities 1710. Additional plating may be formed to form interconnects over and below the dielectric layer and/or the filler.

Stage 4, as shown in FIG. 17B, illustrates a state after an antenna 201 is formed that is coupled to the plurality of via interconnects 203. The antenna 201 may be formed from the seed layer 1701. In some implementations, one or more metal layers may be formed over the seed layer 1701, and the additional metal layer(s) and/or the seed layer 1701 may be etched to form the antenna 201. In some implementations, a metal layer 390c may be formed and coupled to the core layer 202. The metal layer 390c may be formed from the seed layer 1703. The metal layer 390c may be a waveguide metal layer 390c. In some implementations, one or more metal layers may be formed over the seed layer 1703, and the additional metal layer(s)s and/or the seed layer 1703 may be etched to form the metal layer 390c. In some implementations, one or more metal layers may be formed over the seed layer 1703, and the additional metal layer(s) and/or the seed layer 1703 may form the plurality of interconnects 1711. The plurality of interconnects 1711 may be coupled to the plurality of via interconnects 203. A plating process and/or an etching process may be used to form the antenna 201, the plurality of interconnects 1711 and the metal layer 390c.

Stage 5 illustrates a state after a dielectric layer 220 and a dielectric layer 222 are formed and coupled to the core layer 202. The dielectric layer 220 may be coupled to a first surface of the core layer 202. The dielectric layer 222 may be coupled to a second surface of the core layer 202. A deposition process and/or a lamination process may be used to form the dielectric layer 220 and/or the dielectric layer 222.

Stage 6 illustrates a state after a plurality of cavities 1721 are formed in the dielectric layer 220. An exposure, a development and/or an etching process may be used to pattern the dielectric layer 220, which creates cavities 1721 and/or openings in the dielectric layer 220.

Stage 7, as shown in FIG. 17C, illustrates a state after a plurality of interconnects 1724 are formed in the dielectric layer 220. The plurality of interconnects 1724 may be formed in and/or on the dielectric layer 220. The plurality of interconnects 1724 may be coupled to the plurality of interconnects 1711. A plating process may be used to form the plurality of interconnects 1724.

Stage 8 illustrates a state after a solder resist layer 206 and a solder resist layer 208 are formed. The solder resist layer 206 may be coupled to the dielectric layer 220. The solder resist layer 208 may be coupled to the dielectric layer 222. The solder resist layer 206 may include a plurality of openings that exposes a plurality of interconnects 205. The plurality of interconnects 205 may represent the plurality of interconnects 1724 and/or the plurality of interconnects 1711. A deposition process and/or a lamination process may be used to form the solder resist layer 206 and/or the solder resist layer 208.

Stage 9 illustrates a state after a plurality of solder interconnects 207 are coupled to a plurality of interconnects 205, through openings in the solder resist layer 206. A solder reflow process may be used to form the plurality of solder interconnects 207 and couple them to the plurality of interconnects 205.

Stage 10, as shown in FIG. 17D, illustrates a state after a film 1730 (e.g., film layer, film attach) is coupled to the solder resist layer 206 and the plurality of solder interconnects 207. The film 1730 may cover the plurality of solder interconnects 207. Stage 10 may illustrates a structure 1740 that includes the core layer 202, a plurality of antennas 201, at least one via interconnect 203, a plurality of interconnects a dielectric layer 220, a dielectric layer 222, a solder resist layer 206, a solder resist layer 208, the plurality of solder interconnects 207 and the film 1730. The structure 1740 may be a substrate panel.

Stage 11 illustrates a state after a dicing process that cuts the structure 1740 into a plurality of devices 1750. A mechanical process (e.g., saw process) may be used to cut and/or deice the structure 1740 into a plurality of devices 1750.

Stage 12 illustrates a state after the plurality of devices 1750 are placed and coupled to the carrier 1760, such that the solder resist layer 208 is coupled to the carrier 1760. The carrier 1760 may include an adhesive, and the solder resist layer 208 may be coupled to the adhesive of the carrier 1760.

Stage 13, as shown in FIG. 17E, illustrates a state after a metal layer 1790 is formed over the plurality of devices 1750. The metal layer 1790 may be coupled to the film 1730 and on the side surfaces of (i) the core layer 202, (ii) the metal layer 390c, (iii) the dielectric layer 220 and/or (iv) the dielectric layer 222.

Stage 14 illustrates a state after the film 1730 is removed, which also removes portions of the metal layer 1790 that are coupled to and touching the film 1730. The remaining metal layer from the metal layer 1790 may represent the metal layer 390a and the metal layer 390b.

Stage 15 illustrates a state after the plurality of devices 1750 are decoupled from the carrier 1760, leaving with a plurality of antenna devices 300, as described in at least FIG. 3 of the disclosure.

### Exemplary Flow Diagram of a Method for Fabricating an Antenna Device

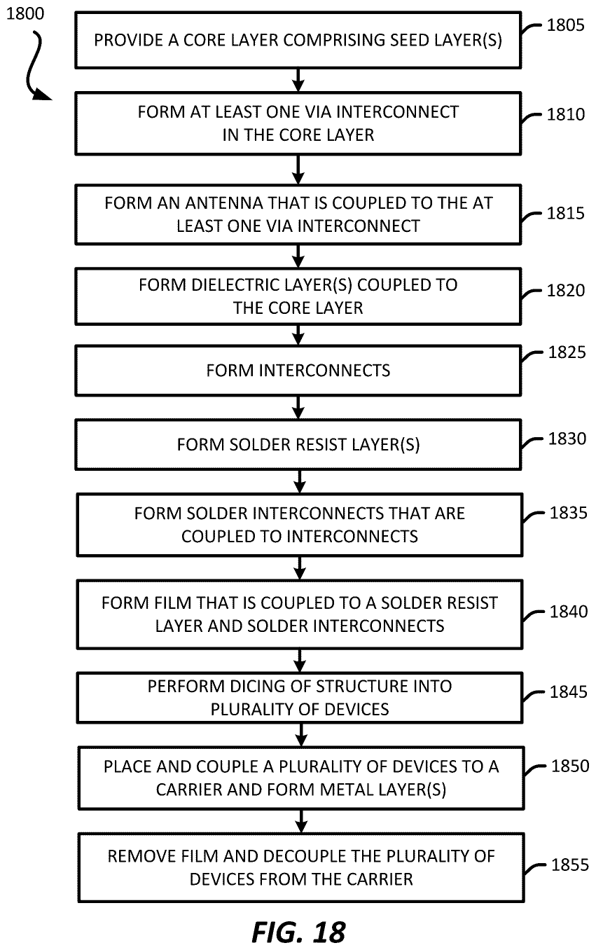

In some implementations, fabricating an antenna device includes several processes. FIG. 18 illustrates an exemplary flow diagram of a method 1800 for providing or fabricating an antenna device. In some implementations, the method 1800 of FIG. 18 may be used to provide or fabricate the antenna device (e.g., 109a). The method 1800 may be implemented on a base (e.g., substrate) and then singulated into several antenna devices.

It should be noted that the method 1800 of FIG. 18 may combine one or more processes in order to simplify and/or clarify the method for providing or fabricating an antenna device. In some implementations, the order of the processes may be changed or modified.

The method provides (at 1805) a core layer. The core layer may include at least one seed layer. Stage 1 of FIG. 17A, illustrates and describes an example of a state after a core layer 202, a seed layer 1701 and a seed layer 1702 are provided. The core layer 202 may include a dielectric layer. The seed layer 1701 and/or the seed layer 1702 may include copper.

The method forms (at 1810) a plurality of via interconnects in the core layer. Forming the plurality of via interconnects may include forming a plurality of cavities in the core layer and forming via interconnects in the plurality of cavities. Stage 2 of FIG. 17A, illustrates and describes an example of a state after a plurality of cavities 1710 are formed through the core layer 202, the seed layer 1701 and/or the seed layer 1703 are formed. A laser process (e.g., laser ablation) may be used to form the plurality of cavities 1710. Stage 3 of FIG. 17A, illustrates and describes an example of a state after a plurality of via interconnects 203 are formed in the plurality of cavities 1710 of the core layer 202. The plurality of via interconnects 203 may include inner via interconnects 230. A plating process may be used to form the via interconnects 203. In some implementations, instead of the inner via interconnects 230, a dielectric layer and/or a filler may be used. In such instances, the via interconnects 203 may be formed, and the dielectric layer and/or the filler may be formed in the cavity 1710. Additional plating may be formed to form interconnects over and below the dielectric layer and/or the filler.

The method forms (at 1815) at least one antenna that is coupled to the via interconnect. Stage 4 of FIG. 17B, illustrates and describes an example of a state after an antenna 201 is formed that is coupled to the plurality of via interconnects 203. The antenna 201 may be formed from the seed layer 1701. In some implementations, one or more metal layers may be formed over the seed layer 1701, and the additional metal layer(s) and/or the seed layer 1701 may be etched to form the antenna 201. In some implementations, a metal layer 390c may be formed and coupled to the core layer 202. The metal layer 390c may be formed from the seed layer 1703. The metal layer 390c may be a waveguide metal layer 390c. In some implementations, one or more metal layers may be formed over the seed layer 1703, and the additional metal layer(s)s and/or the seed layer 1703 may be etched to form the metal layer 390c. In some implementations, one or more metal layers may be formed over the seed layer 1703, and the additional metal layer(s) and/or the seed layer 1703 may form the plurality of interconnects 1711. The plurality of interconnects 1711 may be coupled to the plurality of via interconnects 203. A plating process and/or an etching process may be used to form the antenna 201, the plurality of interconnects 1711 and the metal layer 390c.

The method forms (at 1820) dielectric layer(s) that are coupled to the core layer. Stage 5 of FIG. 17B, illustrates and describes an example of a state after a dielectric layer 220 and a dielectric layer 222 are formed and coupled to the core layer 202. The dielectric layer 220 may be coupled to a first surface of the core layer 202. The dielectric layer 222 may be coupled to a second surface of the core layer 202. A deposition process and/or a lamination process may be used to form the dielectric layer 220 and/or the dielectric layer 222. Forming the dielectric layer(s) may include forming cavities in the dielectric layers. Stage 6 of FIG. 17B, illustrates and describes an example of a state after a plurality of cavities 1721 are formed in the dielectric layer 220. An exposure, a development and/or an etching process may be used to pattern the dielectric layer 220, which creates cavities 1721 and/or openings in the dielectric layer 220.

The method forms (at 1825) interconnects. Stage 7 of FIG. 17C, illustrates and describes an example of state after a plurality of interconnects 1724 are formed in the dielectric layer 220. The plurality of interconnects 1724 may be formed in and/or on the dielectric layer 220. The plurality of interconnects 1724 may be coupled to the plurality of interconnects 1711. A plating process may be used to form the plurality of interconnects 1724.

The method forms (at 1830) solder resist layers that are coupled to the dielectric layer(s). Stage 8 of FIG. 17C, illustrates and describes an example of a state after a solder resist layer 206 and a solder resist layer 208 are formed. The solder resist layer 206 may be coupled to the dielectric layer 220. The solder resist layer 208 may be coupled to the dielectric layer 222. The solder resist layer 206 may include a plurality of openings that exposes a plurality of interconnects 205. The plurality of interconnects 205 may represent the plurality of interconnects 1724 and/or the plurality of interconnects 1711. A deposition process and/or a lamination process may be used to form the solder resist layer 206 and/or the solder resist layer 208.

The method forms and couples (at 1835) solder interconnects to the interconnects. Stage 9 of FIG. 17C, illustrates and describes an example of a state after a plurality of solder interconnects 207 are coupled to a plurality of interconnects 205, through openings in the solder resist layer 206. A solder reflow process may be used to form the plurality of solder interconnects 207 and couple them to the plurality of interconnects 205.

The method forms and couples (at 1840) a film to a solder resist layer and solder interconnects. Stage 10 of FIG. 17D, illustrates and describes an example of a state after a film 1730 (e.g., film layer, film attach) is coupled to the solder resist layer 206 and the plurality of solder interconnects 207. The film 1730 may cover the plurality of solder interconnects 207. Stage 10 may illustrates a structure 1740 that includes the core layer 202, a plurality of antennas 201, at least one via interconnect 203, a plurality of interconnects a dielectric layer 220, a dielectric layer 222, a solder resist layer 206, a solder resist layer 208, the plurality of solder interconnects 207 and the film 1730. The structure 1740 may be a substrate panel.

The method performs (at 1845) a dicing of a structure. Stage 11 of FIG. 17D, illustrates and describes an example of a state after a dicing process that cuts the structure 1740 into a plurality of devices 1750. A mechanical process (e.g., saw process) may be used to cut and/or deice the structure 1740 into a plurality of devices 1750.

The method places and couples (at 1850) a plurality of devices to a carrier. Stage 12 of FIG. 17D, illustrates and describes an example of a state after the plurality of devices 1750 are placed and coupled to the carrier 1760, such that the solder resist layer 208 is coupled to the carrier 1760. The carrier 1760 may include an adhesive, and the solder resist layer 208 may be coupled to the adhesive of the carrier 1760. Stage 13 of FIG. 17E, illustrates and describes an example of a state after a metal layer 1790 is formed over the plurality of devices 1750. The metal layer 1790 may be coupled to the film 1730 and on the side surfaces of (i) the core layer 202, (ii) the metal layer 390c, (iii) the dielectric layer 220 and/or (iv) the dielectric layer 222.

The method removes (at 1855) the film and decouples (at 1855) the plurality of devices from the carrier. Stage 14 of FIG. 17E, illustrates and describes an example of a state after the film 1730 is removed, which also removes portions of the metal layer 1790 that are coupled to and touching the film 1730. The remaining metal layer from the metal layer 1790 may represent the metal layer 390a and the metal layer 390b. A plating process may be used to form the metal layer 1790. Stage 15 of FIG. 17E, illustrates and describes an example of a state after the plurality of devices 1750 are decoupled from the carrier 1760, leaving with a plurality of antenna devices 300, as described in at least FIG. 3 of the disclosure.

### Exemplary Sequence for Fabricating an Antenna Device

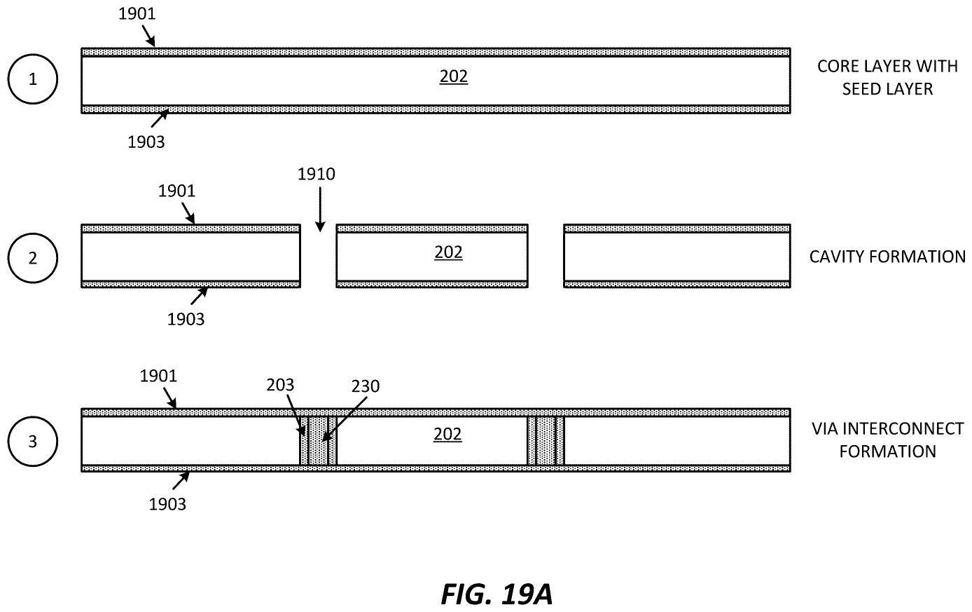

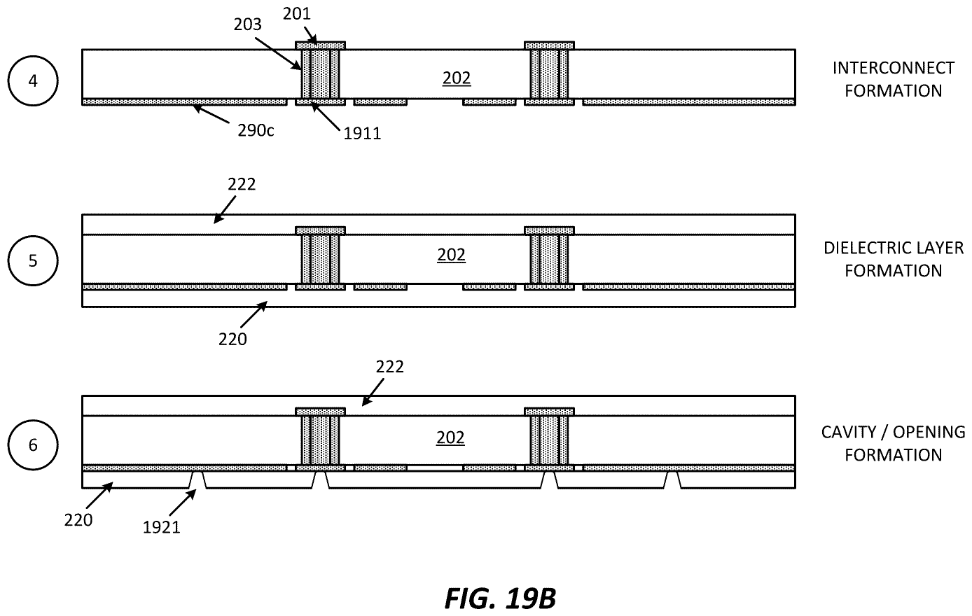

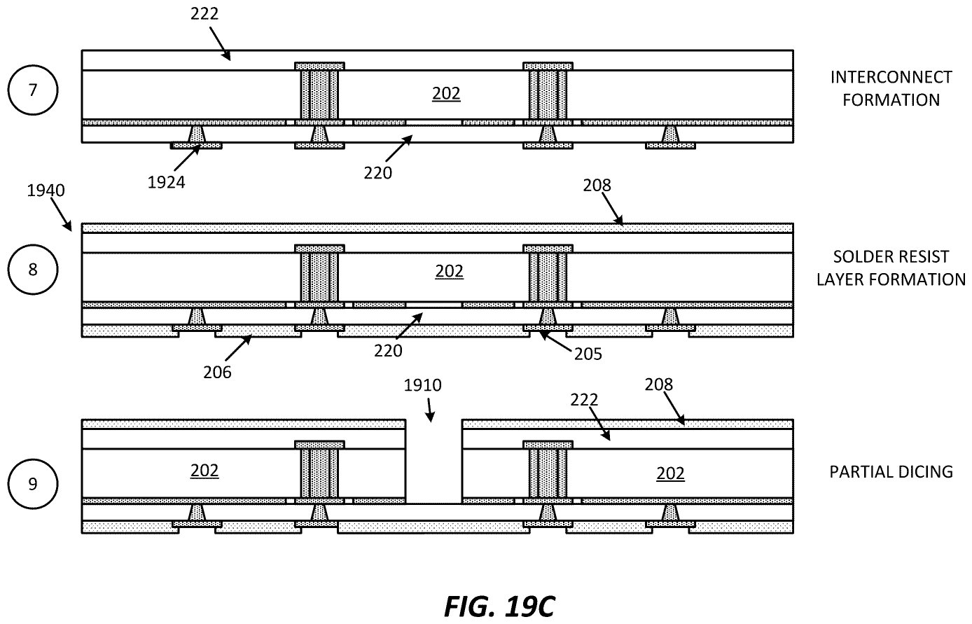

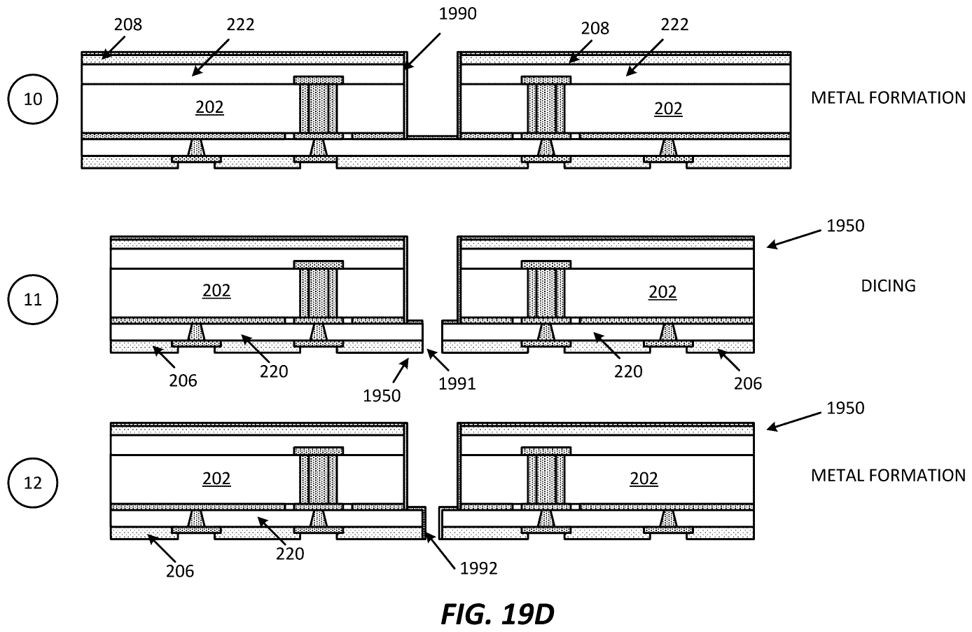

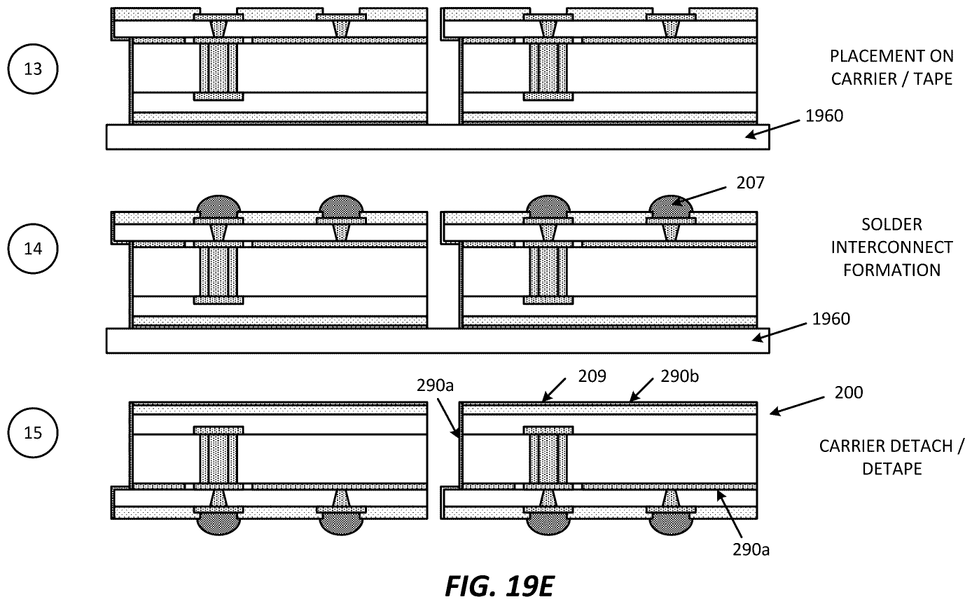

FIGS. 19A-19E illustrate an exemplary sequence for providing or fabricating an antenna device. In some implementations, the sequence of FIGS. 19A-19E may be used to provide or fabricate any of the substrates described in the disclosure. In some implementations, the sequence of FIGS. 19A-19E may be used to provide or fabricate the antenna device (e.g., 200) described in the disclosure. However, the sequence of FIGS. 19A-19E may be used to fabricate any antenna device described by the disclosure.

It should be noted that the sequence of FIGS. 19A-19E may combine one or more stages in order to simplify and/or clarify the sequence for providing or fabricating an antenna device. In some implementations, the order of the processes may be changed or modified. In some implementations, one or more of processes may be replaced or substituted without departing from the spirit of the disclosure. Different implementations may fabricate a substrate differently.

Stage 1, as shown in FIG. 19A, illustrates a state after a core layer 202, a seed layer 1901 and a seed layer 1902 are provided. The core layer 202 may include a dielectric layer. The seed layer 1901 and/or the seed layer 1902 may include copper.

Stage 2 illustrates a state after a plurality of cavities 1910 are formed through the core layer 202, the seed layer 1901 and/or the seed layer 1903 are formed. A laser process (e.g., laser ablation) may be used to form the plurality of cavities 1910.

Stage 3 illustrates a state after a plurality of via interconnects 203 are formed in the plurality of cavities 1910 of the core layer 202. The plurality of via interconnects 203 may include inner via interconnects 230. A plating process may be used to form the via interconnects 203. In some implementations, instead of the inner via interconnects 230, a dielectric layer and/or a filler may be used. In such instances, the via interconnects 203 may be formed, and the dielectric layer and/or the filler may be formed in the cavity 1901. Additional plating may be formed to form interconnects over and below the dielectric layer and/or the filler.

Stage 4, as shown in FIG. 19B, illustrates a state after an antenna 201 is formed that is coupled to the plurality of via interconnects 203. The antenna 201 may be formed from the seed layer 1901. In some implementations, one or more metal layers may be formed over the seed layer 1901, and the additional metal layer(s) and/or the seed layer 1901 may be etched to form the antenna 201. In some implementations, a metal layer 290c may be formed and coupled to the core layer 202. The metal layer 290c may be formed from the seed layer 1703. The metal layer 290c may be a waveguide metal layer. In some implementations, one or more metal layers may be formed over the seed layer 1903, and the additional metal layer(s)s and/or the seed layer 1903 may be etched to form the metal layer 290c. In some implementations, one or more metal layers may be formed over the seed layer 1903, and the additional metal layer(s) and/or the seed layer 1903 may form the plurality of interconnects 1911. The plurality of interconnects 1911 may be coupled to the plurality of via interconnects 203. A plating process and/or an etching process may be used to form the antenna 201, the plurality of interconnects 1911 and the metal layer 290c.

Stage 5 illustrates a state after a dielectric layer 220 and a dielectric layer 222 are formed and coupled to the core layer 202. The dielectric layer 220 may be coupled to a first surface of the core layer 202. The dielectric layer 222 may be coupled to a second surface of the core layer 202. A deposition process and/or a lamination process may be used to form the dielectric layer 220 and/or the dielectric layer 222.

Stage 6 illustrates a state after a plurality of cavities 1921 are formed in the dielectric layer 220. An exposure, a development and/or an etching process may be used to pattern the dielectric layer 220, which creates cavities 1921 and/or openings in the dielectric layer 220.

Stage 7, as shown in FIG. 19C, illustrates a state after a plurality of interconnects 1924 are formed in the dielectric layer 220. The plurality of interconnects 1924 may be formed in and/or on the dielectric layer 220. The plurality of interconnects 1924 may be coupled to the plurality of interconnects 1911. A plating process may be used to form the plurality of interconnects 1924.

Stage 8 illustrates a state after a solder resist layer 206 and a solder resist layer 208 are formed. The solder resist layer 206 may be coupled to the dielectric layer 220. The solder resist layer 208 may be coupled to the dielectric layer 222. The solder resist layer 206 may include a plurality of openings that exposes a plurality of interconnects 205. The plurality of interconnects 205 may represent the plurality of interconnects 1924 and/or the plurality of interconnects 1911. A deposition process and/or a lamination process may be used to form the solder resist layer 206 and/or the solder resist layer 208.

Stage 8 may illustrates a structure 1940 that includes the core layer 202, a plurality of antennas 201, at least one via interconnect 203, a plurality of interconnects a dielectric layer 220, a dielectric layer 222, a solder resist layer 206 and a solder resist layer 208. The structure 1940 may be a substrate panel.

Stage 9 illustrates a state after the structure 1940 is partially diced. A saw process may partially dice and/or the partially cut the structure 1940. The dicing process may cut through the solder resist layer 208, the dielectric layer 222 and the core layer 202.

Stage 10, as shown in FIG. 19D, illustrates a state after a metal layer 1990 is formed. The metal layer 1990 may be coupled to a surface of the solder resist layer 208, a side surface of the solder resist layer 208, a side surface of the dielectric layer 222, a side surface of the core layer 202 and a surface of the dielectric layer 220. A plating process may be used to form the metal layer 1990.

Stage 11 illustrates a state after the dielectric layer 220 and the solder resist layer 206 are cut and/or diced. A saw process may be used to cut the dielectric layer 220 and the solder resist layer 206.

Stage 12 illustrates a state after a metal layer 1992 is formed. The metal layer 1992 may be coupled to a side surface of the dielectric layer 220 and a side surface of the solder resist layer 206. The metal layer 1992 may be coupled to the metal layer 1990. The metal layer 1992 may be considered part of the metal layer 1990. The metal layer 1990 may represent the metal layer 290a and/or the metal layer 290b of a waveguide, as described in at least FIG. 2. Stage 11 and/or stage 12 may represent a plurality of devices 1950.

Stage 13, as shown in FIG. 19E, illustrates a state after the plurality of devices 1950 are placed and coupled to the carrier 1960, such that the metal layer 1990 is coupled to the carrier 1960. The carrier 1960 may include an adhesive, and the metal layer 1990 may be coupled to the adhesive of the carrier 1960.

Stage 14 illustrates a state after a plurality of solder interconnects 207 are coupled to a plurality of interconnects 205, through openings in the solder resist layer 206. A solder reflow process may be used to form the plurality of solder interconnects 207 and couple them to the plurality of interconnects 205.

Stage 15 illustrates a state after the plurality of devices 1950 are decoupled from the carrier 1960, leaving with a plurality of antenna devices 200, as described in at least FIG. 2 of the disclosure.

### Exemplary Flow Diagram of a Method for Fabricating an Antenna Device

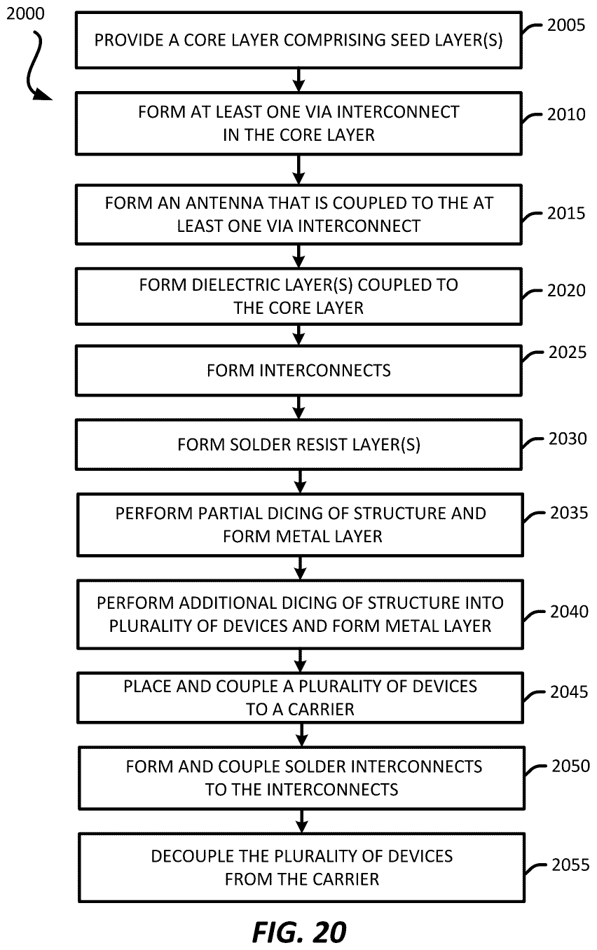

In some implementations, fabricating an antenna device includes several processes. FIG. 20 illustrates an exemplary flow diagram of a method 2000 for providing or fabricating an antenna device. In some implementations, the method 2000 of FIG. 20 may be used to provide or fabricate the antenna device (e.g., 109a). The method 2000 may be implemented on a base (e.g., substrate) and then singulated into several antenna devices.

It should be noted that the method 2000 of FIG. 20 may combine one or more processes in order to simplify and/or clarify the method for providing or fabricating an antenna device. In some implementations, the order of the processes may be changed or modified.

The method provides (at 2005) a core layer. The core layer may include at least one seed layer. Stage 1 of FIG. 19A, illustrates and describes an example of a state after a core layer 202, a seed layer 1901 and a seed layer 1902 are provided. The core layer 202 may include a dielectric layer. The seed layer 1901 and/or the seed layer 1902 may include copper.

The method forms (at 2010) a plurality of via interconnects in the core layer. Forming the plurality of via interconnects may include forming a plurality of cavities in the core layer and forming via interconnects in the plurality of cavities. Stage 2 of FIG. 19A, illustrates and describes an example of a state after a plurality of cavities 1910 are formed through the core layer 202, the seed layer 1901 and/or the seed layer 1903 are formed. A laser process (e.g., laser ablation) may be used to form the plurality of cavities 1910. Stage 3 of FIG. 19A, illustrates and describes an example of a state after a plurality of via interconnects 203 are formed in the plurality of cavities 1910 of the core layer 202. The plurality of via interconnects 203 may include inner via interconnects 230. A plating process may be used to form the via interconnects 203. In some implementations, instead of the inner via interconnects 230, a dielectric layer and/or a filler may be used. In such instances, the via interconnects 203 may be formed, and the dielectric layer and/or the filler may be formed in the plurality of cavities 1910. Additional plating may be formed to form interconnects over and below the dielectric layer and/or the filler.

The method forms (at 2015) at least one antenna that is coupled to the via interconnect. Stage 4 of FIG. 19B, illustrates and describes an example of a state after an antenna 201 is formed that is coupled to the plurality of via interconnects 203. The antenna 201 may be formed from the seed layer 1901. In some implementations, one or more metal layers may be formed over the seed layer 1901, and the additional metal layer(s) and/or the seed layer 1901 may be etched to form the antenna 201. In some implementations, a metal layer 390c may be formed and coupled to the core layer 202. The metal layer 390c may be formed from the seed layer 1903. The metal layer 390c may be a waveguide metal layer. In some implementations, one or more metal layers may be formed over the seed layer 1903, and the additional metal layer(s)s and/or the seed layer 1903 may be etched to form the metal layer 390c. In some implementations, one or more metal layers may be formed over the seed layer 1903, and the additional metal layer(s) and/or the seed layer 1903 may form the plurality of interconnects 1911. The plurality of interconnects 1911 may be coupled to the plurality of via interconnects 203. A plating process and/or an etching process may be used to form the antenna 201, the plurality of interconnects 1911 and the metal layer 390c.

The method forms (at 2020) dielectric layer(s) that are coupled to the core layer. Stage 5 of FIG. 19B, illustrates and describes an example of a state after a dielectric layer 220 and a dielectric layer 222 are formed and coupled to the core layer 202. The dielectric layer 220 may be coupled to a first surface of the core layer 202. The dielectric layer 222 may be coupled to a second surface of the core layer 202. A deposition process and/or a lamination process may be used to form the dielectric layer 220 and/or the dielectric layer 222. Forming the dielectric layer(s) may include forming cavities in the dielectric layers. Stage 6 of FIG. 19B, illustrates and describes an example of a state after a plurality of cavities 1921 are formed in the dielectric layer 220. An exposure, a development and/or an etching process may be used to pattern the dielectric layer 220, which creates cavities 1921 and/or openings in the dielectric layer 220.

The method forms (at 2025) interconnects. Stage 7 of FIG. 19C, illustrates and describes an example of state after a plurality of interconnects 1924 are formed in the dielectric layer 220. The plurality of interconnects 1924 may be formed in and/or on the dielectric layer 220. The plurality of interconnects 1924 may be coupled to the plurality of interconnects 1911. A plating process may be used to form the plurality of interconnects 1924.

The method forms (at 2030) solder resist layers that are coupled to the dielectric layer(s). Stage 8 of FIG. 19C, illustrates and describes an example of a state after a solder resist layer 206 and a solder resist layer 208 are formed. The solder resist layer 206 may be coupled to the dielectric layer 220. The solder resist layer 208 may be coupled to the dielectric layer 222. The solder resist layer 206 may include a plurality of openings that exposes a plurality of interconnects 205. The plurality of interconnects 205 may represent the plurality of interconnects 1924 and/or the plurality of interconnects 1911. A deposition process and/or a lamination process may be used to form the solder resist layer 206 and/or the solder resist layer 208.

Stage 8 may illustrates a structure 1940 that includes the core layer 202, a plurality of antennas 201, at least one via interconnect 203, a plurality of interconnects a dielectric layer 220, a dielectric layer 222, a solder resist layer 206 and a solder resist layer 208. The structure 1940 may be a substrate panel.

The method performs (at 2035) a partial dicing of the structure and forms a metal layer. Stage 9 of FIG. 19C, illustrates and describes an example of a state after the structure 1940 is partially diced. A saw process may partially dice and/or the partially cut the structure 1940. The dicing process may cut through the solder resist layer 208, the dielectric layer 222 and the core layer 202.

Stage 10 of FIG. 19D, illustrates a state after a metal layer 1990 is formed. The metal layer 1990 may be coupled to a surface of the solder resist layer 208, a side surface of the solder resist layer 208, a side surface of the dielectric layer 222, a side surface of the core layer 202 and a surface of the dielectric layer 220. A plating process may be used to form the metal layer 1990.

The method performs (at 2040) another dicing of the structure and forms a metal layer. Stage 11 of FIG. 19D, illustrates and describes an example of a state after the dielectric layer 220 and the solder resist layer 206 are cut and/or diced. A saw process may be used to cut the dielectric layer 220 and the solder resist layer 206.

Stage 12 of FIG. 19D, illustrates and describes an example of a state after a metal layer 1992 is formed. The metal layer 1992 may be coupled to a side surface of the dielectric layer 220 and a side surface of the solder resist layer 206. The metal layer 1992 may be coupled to the metal layer 1990. The metal layer 1992 may be considered part of the metal layer 1990. The metal layer 1990 may represent the metal layer 290a and/or the metal layer 290b of a waveguide, as described in at least FIG. 2. Stage 11 and/or stage 12 may represent a plurality of devices 1950.

The method places and couples (at 2045) a plurality of devices on a carrier. Stage 13, as shown in FIG. 19E, illustrates a state after the plurality of devices 1950 are placed and coupled to the carrier 1960, such that the metal layer 1990 is coupled to the carrier 1960. The carrier 1960 may include an adhesive, and the metal layer 1990 may be coupled to the adhesive of the carrier 1960.

The method forms and couples (at 2050) solder interconnects to the interconnects. Stage 14 of FIG. 19E, illustrates and describes an example of a state after a plurality of solder interconnects 207 are coupled to a plurality of interconnects 205, through openings in the solder resist layer 206. A solder reflow process may be used to form the plurality of solder interconnects 207 and couple them to the plurality of interconnects 205.

The method decouples (at 2055) the plurality of devices from the carrier. Stage 15 of FIG. 19E, illustrates and describes an example of a state after the plurality of devices 1950 are decoupled from the carrier 1960, leaving with a plurality of antenna devices 200, as described in at least FIG. 2 of the disclosure.

### Exemplary Electronic Devices

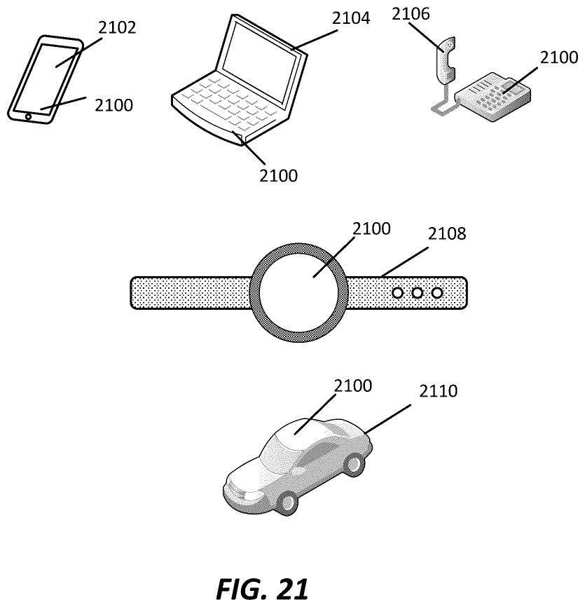

FIG. 21 illustrates various electronic devices that may be integrated with any of the aforementioned device, integrated device, integrated circuit (IC) package, integrated circuit (IC) device, semiconductor device, integrated circuit, die, interposer, package, package-on-package (PoP), System in Package (SiP), or System on Chip (SoC). For example, a mobile phone device 2102, a laptop computer device 2104, a fixed location terminal device 2106, a wearable device 2108, or automotive vehicle 2110 may include a device 2100 as described herein. The device 2100 may be, for example, any of the devices and/or integrated circuit (IC) packages described herein. The devices 2102, 2104, 2106 and 2108 and the vehicle 2110 illustrated in FIG. 21 are merely exemplary. Other electronic devices may also feature the device 2100 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices (e.g., watches, glasses), Internet of things (IoT) devices, servers, routers, electronic devices implemented in automotive vehicles (e.g., autonomous vehicles), or any other device that stores or retrieves data or computer instructions, or any combination thereof.

One or more of the components, processes, features, and/or functions illustrated in FIGS. 1-16, 17A-17E, 18, 19A-19E, and/or 20-21 may be rearranged and/or combined into a single component, process, feature or function or embodied in several components, processes, or functions. Additional elements, components, processes, and/or functions may also be added without departing from the disclosure. It should also be noted FIGS. 1-16, 17A-17E, 18, 19A-19E, and/or 20-21 and its corresponding description in the present disclosure is not limited to dies and/or ICs. In some implementations, FIGS. 1-16, 17A-17E, 18, 19A-19E, and/or 20-21 and its corresponding description may be used to manufacture, create, provide, and/or produce devices and/or integrated devices. In some implementations, a device may include a die, an integrated device, an integrated passive device (IPD), a die package, an integrated circuit (IC) device, a device package, an integrated circuit (IC) package, a wafer, a semiconductor device, a package-on-package (PoP) device, a heat dissipating device and/or an interposer.

It is noted that the figures in the disclosure may represent actual representations and/or conceptual representations of various parts, components, objects, devices, packages, integrated devices, integrated circuits, and/or transistors. In some instances, the figures may not be to scale. In some instances, for purpose of clarity, not all components and/or parts may be shown. In some instances, the position, the location, the sizes, and/or the shapes of various parts and/or components in the figures may be exemplary. In some implementations, various components and/or parts in the figures may be optional.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling (e.g., mechanical coupling) between two objects. For example, if object A physically touches object B, and object B touches object C, then objects A and C may still be considered coupled to one another—even if they do not directly physically touch each other. The term “electrically coupled” may mean that two objects are directly or indirectly coupled together such that an electrical current (e.g., signal, power, ground) may travel between the two objects. Two objects that are electrically coupled may or may not have an electrical current traveling between the two objects. The use of the terms “first”, “second”, “third” and “fourth” (and/or anything above fourth) is arbitrary. Any of the components described may be the first component, the second component, the third component or the fourth component. For example, a component that is referred to a second component, may be the first component, the second component, the third component or the fourth component. The term “encapsulating” means that the object may partially encapsulate or completely encapsulate another object. A first component that is “located” in a second component may mean that the first component is “partially located” in the second component or “completely located” in the second component. A first component that is “embedded” in a second component may mean that the first component is “partially embedded” in the second component or “completely embedded” in the second component. The terms “top” and “bottom” are arbitrary. A component that is located on top may be located over a component that is located on a bottom. A top component may be considered a bottom component, and vice versa. As described in the disclosure, a first component that is located “over” a second component may mean that the first component is located above or below the second component, depending on how a bottom or top is arbitrarily defined. In another example, a first component may be located over (e.g., above) a first surface of the second component, and a third component may be located over (e.g., below) a second surface of the second component, where the second surface is opposite to the first surface. It is further noted that the term “over” as used in the present application in the context of one component located over another component, may be used to mean a component that is on another component and/or in another component (e.g., on a surface of a component or embedded in a component). Thus, for example, a first component that is over the second component may mean that (1) the first component is over the second component, but not directly touching the second component, (2) the first component is on (e.g., on a surface of) the second component, and/or (3) the first component is in (e.g., embedded in) the second component. A first component that is located “in” a second component may be partially located in the second component or completely located in the second component. The term “about ‘value X’”, or “approximately value X”, as used in the disclosure means within 10 percent of the ‘value X’. For example, a value of about 1 or approximately 1, would mean a value in a range of 0.9-1.1.

In some implementations, an interconnect is an element or component of a device or package that allows or facilitates an electrical connection between two points, elements and/or components. In some implementations, an interconnect may include a trace, a via, a pad, a pillar, a metallization layer, a redistribution layer, and/or an under bump metallization (UBM) layer/interconnect. In some implementations, an interconnect may include an electrically conductive material that may be configured to provide an electrical path for a signal (e.g., a data signal), ground and/or power. An interconnect may include more than one element or component. An interconnect may be defined by one or more interconnects. An interconnect may include one or more metal layers. An interconnect may be part of a circuit. Different implementations may use different processes and/or sequences for forming the interconnects. In some implementations, a chemical vapor deposition (CVD) process, a physical vapor deposition (PVD) process, a sputtering process, a spray coating, and/or a plating process may be used to form the interconnects.

Also, it is noted that various disclosures contained herein may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed.

In the following, further examples are described to facilitate the understanding of the disclosure.

Aspect 1: An antenna device comprising an antenna device dielectric layer; at least one antenna located in the antenna device dielectric layer; at least one waveguide metal layer; and at least one opening on a first surface of the antenna device.

Aspect 2: The antenna device of aspect 1, further comprising a solder resist layer coupled to a surface of the antenna device dielectric layer.

Aspect 3: The antenna device of aspect 2, wherein the at least one waveguide metal layer is coupled to the solder resist layer, and wherein the solder resist layer is located between the at least one waveguide metal layer and the antenna device dielectric layer.

Aspect 4: The antenna device of aspect 1, wherein the antenna device comprises a first side surface; a second side surface; a third side surface; a fourth side surface; a top surface; and a bottom surface.

Aspect 5: The antenna device of aspect 4,wherein the at least one opening of the antenna device is on the first side surface, and wherein the at least one waveguide metal layer is on the second side surface.

Aspect 6: The antenna device of aspect 5, wherein the at least one waveguide metal layer is further on the third side surface and the fourth side surface.

Aspect 7: The antenna device of aspect 6, wherein the at least one waveguide metal layer is further on the top surface of the antenna device.

Aspect 8: The antenna device of aspect 5, wherein the at least one opening of the antenna device is on the third side surface.

Aspect 9: The antenna device of aspect 5, wherein the at least one opening of the antenna device is on the top surface.

Aspect 10: The antenna device of aspect 1, wherein the antenna device dielectric layer includes a top surface and a bottom surface, and wherein the at least one waveguide metal layer is coupled to a bottom surface of the antenna device dielectric layer.

Aspect 11: The antenna device of aspect 1, wherein the antenna device is configured to transmit and receive signals through the at least one opening of the antenna device.

Aspect 12: The antenna device of aspect 1, wherein the antenna device is configured to transmit and receive signals through at least one lateral surface of the antenna device.

Aspect 13: The antenna device of aspect 1, wherein the antenna device is configured to transmit and receive signals through at least one horizontal surface of the antenna device.

Aspect 14: The antenna device of aspect 1, wherein the at least one waveguide metal layer is configured to direct signals through the at least one opening of the antenna device.

Aspect 15: The antenna device of aspect 1, wherein the antenna device is configured to transmit signals in a first horizontal direction and a second horizontal direction.

Aspect 16: The antenna device of aspect 15, wherein the second horizontal direction is opposite to the first horizontal direction, and/or wherein the second horizontal direction is orthogonal to the first horizontal direction.

Aspect 17: The antenna device of aspect 1, wherein the at least one antenna is at least one antenna feed, wherein the at least one waveguide metal layer is configured as a waveguide antenna, and wherein the waveguide antenna is configured to transmit and receive signals through at least one lateral surface of the antenna device.

Aspect 18: An antenna device comprising an antenna device dielectric layer; at least one antenna feed located in the antenna device dielectric layer; a waveguide antenna; and at least one opening on a first surface of the antenna device.

Aspect 19: The antenna device of claim 18, wherein the waveguide antenna includes a first waveguide metal layer, a second waveguide metal layer and a third waveguide metal layer.

Aspect 20: The antenna device of aspect 19, wherein the first waveguide metal layer is a first waveguide side metal layer, wherein the second waveguide metal layer is a second waveguide side metal layer, wherein the third waveguide metal layer is a waveguide bottom metal layer, and wherein the first waveguide metal layer, the second waveguide side metal layer and the waveguide bottom metal layer are configured to reflect signals towards the at least one antenna feed.

Aspect 21: The antenna device of aspect 18, further comprising a solder resist layer coupled to a surface of the antenna device dielectric layer.

Aspect 22: The antenna device of aspect 18, wherein the waveguide antenna is coupled to the solder resist layer, and wherein the solder resist layer is located between the waveguide antenna and the antenna device dielectric layer.

Aspect 23: The antenna device of aspect 18, wherein the at least one opening of the antenna device is on a side surface of the antenna device.

Aspect 24: The antenna device of aspect 23, wherein the at least one opening of the antenna device is on a top surface of the antenna device.

Aspect 25: The antenna device of aspect 18, wherein the antenna device is configured to transmit and receive signals through the at least one opening of the antenna device.

Aspect 26: The antenna device of aspect 18, wherein the antenna device is configured to transmit and receive signals through at least one lateral surface of the antenna device.

Aspect 27: The antenna device of aspect 18, wherein the antenna device is configured to transmit and receive signals through at least one horizontal surface of the antenna device.

Aspect 28: The antenna device of aspect 18, wherein the waveguide antenna is configured to direct signals through the at least one opening of the antenna device.

Aspect 29: The antenna device of aspect 18, wherein the antenna device is configured to transmit signals in a first horizontal direction and a second horizontal direction.

Aspect 30: The antenna device of aspects 1 through 29, wherein the waveguide antenna forms a partial enclosure that partially surrounds the at least one antenna feed.

Aspect 31: The antenna device of aspects 1 through 30, wherein the antenna device is implemented in a device from a group consisting one of a music player, a video player, an entertainment unit, a navigation device, a communications device, a mobile device, a mobile phone, a smartphone, a personal digital assistant, a fixed location terminal, a tablet computer, a computer, a wearable device, a laptop computer, a server, an internet of things (IoT) device, and a device in an automotive vehicle.

The various features of the disclosure described herein can be implemented in different systems without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

1. An antenna device comprising:
an antenna device dielectric layer;
at least one antenna located in the antenna device dielectric layer;
at least one waveguide metal layer; and
at least one opening on a first surface of the antenna device.

2. The antenna device of claim 1, further comprising a solder resist layer coupled to a surface of the antenna device dielectric layer.

3. The antenna device of claim 2,
wherein the at least one waveguide metal layer is coupled to the solder resist layer, and
wherein the solder resist layer is located between the at least one waveguide metal layer and the antenna device dielectric layer.

4. The antenna device of claim 1, wherein the antenna device comprises:
a first side surface;
a second side surface;
a third side surface;
a fourth side surface;
a top surface; and
a bottom surface.

5. The antenna device of claim 4,
wherein the at least one opening of the antenna device is on the first side surface, and
wherein the at least one waveguide metal layer is on the second side surface.

6. The antenna device of claim 5, wherein the at least one waveguide metal layer is further on the third side surface and the fourth side surface.

7. The antenna device of claim 6, wherein the at least one waveguide metal layer is further on the top surface of the antenna device.

8. The antenna device of claim 5, wherein the at least one opening of the antenna device is on the third side surface.

9. The antenna device of claim 5, wherein the at least one opening of the antenna device is on the top surface.

10. The antenna device of claim 1,
wherein the antenna device dielectric layer includes a top surface and a bottom surface, and
wherein the at least one waveguide metal layer is coupled to a bottom surface of the antenna device dielectric layer.

11. The antenna device of claim 1, wherein the antenna device is configured to transmit and receive signals through the at least one opening of the antenna device.

12. The antenna device of claim 1, wherein the antenna device is configured to transmit and receive signals through at least one lateral surface of the antenna device.

13. The antenna device of claim 1, wherein the antenna device is configured to transmit and receive signals through at least one horizontal surface of the antenna device.

14. The antenna device of claim 1, wherein the at least one waveguide metal layer is configured to direct signals through the at least one opening of the antenna device.

15. The antenna device of claim 1, wherein the antenna device is configured to transmit signals in a first horizontal direction and a second horizontal direction.

16. The antenna device of claim 15,
wherein the second horizontal direction is opposite to the first horizontal direction, or
wherein the second horizontal direction is orthogonal to the first horizontal direction.

17. The antenna device of claim 1,
wherein the at least one antenna is at least one antenna feed,
wherein the at least one waveguide metal layer is configured as a waveguide antenna, and
wherein the waveguide antenna is configured to transmit and receive signals through at least one lateral surface of the antenna device.

18. An antenna device comprising:
an antenna device dielectric layer;
at least one antenna feed located in the antenna device dielectric layer;
a waveguide antenna; and
at least one opening on a first surface of the antenna device.

19. The antenna device of claim 18, wherein the waveguide antenna includes a first waveguide metal layer, a second waveguide metal layer and a third waveguide metal layer.

20. The antenna device of claim 19,
wherein the first waveguide metal layer is a first waveguide side metal layer,
wherein the second waveguide metal layer is a second waveguide side metal layer,
wherein the third waveguide metal layer is a waveguide bottom metal layer, and
wherein the first waveguide metal layer, the second waveguide side metal layer and the waveguide bottom metal layer are configured to reflect signals towards the at least one antenna feed.
